(19) United States
(12) Patent Application Publication
(10) Pub. No.: US 2020/0015509 A1
(43) Pub. Date: Jan. 16, 2020

(54) FOOD PRODUCT PRINTER SYSTEM

(71) Applicant: COCOA PRESS LLC, Philadelphia, PA (US)

(72) Inventor: Evan Weinstein, Philadelphia, PA (US)

(21) Appl. No.: 16/509,840

(22) Filed: Jul. 12, 2019

Related U.S. Application Data
(60) Provisional application No. 62/697,461, filed on Jul. 13, 2018.

(51) Int. Cl. A23P 30/20; A23L 5/30; A23G 1/00; A23G 1/04; B33Y 10/00; B33Y 30/00

(52) U.S. Cl. CPC A23P 30/20; A23L 5/30; A23G 1/0003; A23P 2020/253; B33Y 10/00; B33Y 30/00; A23G 1/04

(57) ABSTRACT

A food product printer system is provided. The food product printer system includes a cartridge configured to receive a food product, and a heating chamber including an opening for placement of the cartridge at least partially therein. The heating chamber is configured to heat the food product to a predetermined temperature for extrusion of the food product from the heating chamber in melted form.

### CROSS-REFERENCE TO RELATED APPLICATIONS

This application claims the benefit of co-pending U.S. Provisional Patent Application No. 62/697,461, which was filed on Jul. 13, 2018. The entire content of the foregoing provisional patent application is incorporated herein by reference.

### BACKGROUND

Popularity in three-dimensional printing using non-edible materials has grown in recent years. However, three-dimensional printing of edible food products (e.g., chocolate, or the like) has not been as widespread due to the delicate nature of the edible printable material as compared to the more durable nature of non-edible materials. As such, while printing of non-edible materials can generally be performed in any environment and the durability of the non-edible material allows for nearly unlimited shapes and/or heights to be printed, traditional three-dimensional printers for edible food products are typically limited in the shape and/or height of the printed food product.

### SUMMARY

The disclosure relates to an edible food product printer system that gradually heats a food product in preparation for printing, and uses a pneumatic actuation system to extrude the food product from a heating chamber. The pneumatic actuation system allows for continuous and smooth extrusion of the food product from the heating chamber, as well as substantially instantaneous reaction time for stopping the extrusion process. The pneumatic actuation system provides for precise extrusion of a food product such as chocolate, allowing for a specific pressure to be used and/or adjusted depending on the type of food product being used. In some embodiments, the system can include a cooling system with a cooling shroud surrounding a nozzle of the heating chamber, the cooling shroud oriented to cool the extruded food product during operation of the system (e.g., during extrusion of the food product). The positioning and angled airflow of the cooling shroud ensures the structural integrity of the printed food product. In some embodiments, the system can include an insulated chamber in which extrusion occurs, and a cooling system for cooling the interior of the insulated chamber to a temperature at which the structural integrity of the printed food product is maintained.

In accordance with some embodiments of the present disclosure, an exemplary food product printer system is provided. The food product printer system includes an extrusion assembly including a heating chamber. The heating chamber is configured to receive a food product and be heated to a predetermined temperature. In some embodiments, the heating chamber can receive an unmelted food product and can be heated to a predetermined temperature to melt the food product. In some embodiments, the heating chamber can receive a food product that can be extruded out of the heating chamber without or with minimal heating. The food product printer system includes a cooling system configured to cool the food product after extrusion from the heating chamber.

The food product printer system includes a heating element disposed around an outer surface of the heating chamber. The heating element can be nichrome wire (or any other elongated conductive element capable of being heated) wound around and secured to the outer surface of the heating chamber. In some embodiments, rather than an elongated conductive element, multiple electrically connected heating elements can be disposed around the surface of the heating chamber to individually heat the heating chamber. In some embodiments, one or more heating elements can be positioned against an outer surface of the heating chamber. The heating elements can be electrically coupled together for being actuated in unison, or can be independently coupled for independent actuation and control. In some embodiments, the predetermined temperature is a range from about 30° C. to about 32° C. The extrusion assembly includes a cartridge disposed within the heating chamber. The cartridge receives therein the unmelted food product. In some embodiments, a position of the cartridge within the heating chamber is maintained by friction (e.g., without fasteners). The food product printer system includes an adapter coupled to the cartridge and fluidically connected to pressurized air. The pressurized air is introduced into the cartridge to extrude the food product from the heating chamber.

The cooling system comprises a cooling shroud at least partially surrounding a nozzle of the heating chamber. In some embodiments, the cooling shroud surrounds the nozzle by approximately 180°. In some embodiments, the cooling shroud surrounds the nozzle by 360°. In some embodiments, the cooling shroud comprises one or a plurality of radial openings formed therein and fluidically connected to a hollow interior of the cooling shroud to direct cold air at the extruded food product. Each of the radial openings is angled by approximately 20° relative to horizontal. In some embodiments, the cold air provided by the cooling shroud can be in the range from, e.g., about 45° F. to about 65° F., about 50° F. to about 60° F., or the like.

The food product printer system includes a build plate movably mounted within a housing. The food product printer system comprises a translation plate coupled to a bottom surface of the build plate, and slidably coupled to tracks within the housing. The food product printer system comprises a translation mechanism coupled to a bottom surface of the translation plate and configured to adjust a vertical position of the translation plate. The food product printer system comprises a translation system for translating the heating chamber along an x-axis and a y-axis. The translation system comprises two bars extending substantially parallel to horizontal, the heating chamber translatable along the two bars on the x-axis. The translation system comprises support flanges coupled to opposing ends of the two bars, the support flanges slidably coupled to side bars, the heating chamber translatable along the side bars on the y-axis.

In accordance with embodiments of the present disclosure, an exemplary method of three-dimensional printing is provided. The method comprises heating an unmelted, solid or semisolid, food product to a predetermined temperature within a heating chamber of an extrusion assembly of a food product printer system (e.g., a temperature range from about 30° C. to about 32° C.). The method comprises extruding the food product from the heating chamber, and cooling the food product with a cooling system after extrusion from the heating chamber.

The method comprises heating a heating element disposed around an outer surface of the heating chamber to heat the heating chamber. The method comprises inserting a cartridge into the heating chamber, the cartridge receiving the unmelted or solid food product. The method comprises introducing pressurized air into the cartridge to extrude the food product from the heating chamber. The method comprises introducing cold air from a cooling shroud of the cooling system onto the extruded food product.

In accordance with embodiments of the present disclosure, an exemplary food product printer system is provided. The food product printer system includes a cartridge configured to receive a food product, and a heating chamber including an opening for placement of the cartridge at least partially therein. The heating chamber is configured to heat the food product to a predetermined temperature for extrusion of the food product from the heating chamber in melted form. The food product printer system includes a cooling system configured to cool the environment surrounding the food product to cool the food product after extrusion from the heating chamber.

The food product printer system includes an elongated heating element concentrically wound around and disposed against an outer surface of the heating chamber. The heating element can be nichrome wire wound around and secured to the outer surface of the heating chamber. The heating chamber can include one or more grooves formed in the outer surface, the elongated heating element configured to at least partially fit within the one or more grooves. The predetermined temperature can be a range from about 30° C. to about 32° C.

The food product printer system includes a connector disposed within a distal end of the cartridge. The connector includes a flange capable of interlocking with a corresponding opening in the heating chamber to maintain a position of the cartridge within the heating chamber. The food product printer system includes a plunger slidably disposed within the cartridge. The food product is extruded from the heating chamber by pressurized air introduced into the cartridge, the pressurized air imparting a force on the plunger to extrude the food product. The pressurized air is in direct contact with the plunger and imparts the force on the plunger without direct contact with the food product. In some embodiments, the food product can be extruded from the heating chamber by pressurized air introduced into the cartridge, the pressurized air imparting a force directly on the food product to extrude the food product (e.g., without the use of the plunger).

The food product printer system includes a detectable element (e.g., a magnet) disposed on or within the plunger and a sensor disposed within or on the heating chamber near a distal end of the heating chamber. Detection of the detectable element by the sensor is indicative of an emptiness of the cartridge. The cooling system includes an air inlet into a build chamber of a housing and an air outlet. The food product printer system includes a build plate movably mounted within a housing, the housing including the cartridge and heating chamber. The food product printer system includes a translation carriage coupled to a bottom surface of the build plate, and slidably coupled to vertical rods within the housing.

In accordance with embodiments of the present disclosure, an exemplary food product printer system is provided. The food product printer system includes a housing including insulated walls defining an inner build chamber, a cartridge configured to receive a food product, and a heating chamber including an opening for placement of the cartridge at least partially therein. The heating chamber is configured to heat the food product to a predetermined temperature. The food product printer system includes a cooling system configured to cool the inner build chamber to a predetermined temperature to cool the food product after extrusion from the heating chamber.

In accordance with embodiments of the present disclosure, an exemplary method of three-dimensional printing of a food product is provided. The method includes placing a cartridge at least partially into a heating chamber, the cartridge including a food product. The method includes heating the food product to a predetermined temperature within a heating chamber. The method includes extruding the food product from the heating chamber in melted form. The method includes cooling the environment surrounding the food product with a cooling system after extrusion from the heating chamber to cool the extruded food product.

The cartridge includes a plunger slidably disposed within the cartridge. The method includes introducing pressurized air into the cartridge to impart a force against the plunger to extrude the food product from the heating chamber. The pressurized air can be in direct contact with the plunger and imparts the force on the plunger without direct contact with the food product. The heating chamber includes an elongated heating element concentrically wound around and disposed against an outer surface of the heating chamber. The heating chamber includes one or more grooves formed in the outer surface, the elongated heating element configured to at least partially fit within the one or more grooves.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed edible food product printer system, reference is made to the accompanying figures, wherein:

FIG. 1 is a front view of an exemplary edible food product printer system of the present disclosure;

FIG. 2 is a perspective view of an exemplary edible food product printer system of FIG. 1;

FIG. 3 is a detailed side view of an exemplary edible food product printer system of FIG. 1;

FIG. 4 is a detailed view of an extrusion assembly and cooling system of an exemplary edible food product printer system of FIG. 1;

FIG. 5 is a top perspective view of an extrusion assembly and cooling system of an exemplary edible food product printer system of FIG. 1;

FIG. 6 is a bottom perspective view of an extrusion assembly and cooling system of an exemplary edible food product printer system of FIG. 1;

FIG. 7 is a rear view of an extrusion assembly and cooling system of an exemplary edible food product printer system of FIG. 1;

FIG. 8 is a right side view of an extrusion assembly and cooling system of an exemplary edible food product printer system of FIG. 1;

FIG. 9 is a cross-sectional view of an extrusion assembly and cooling system of an exemplary edible food product printer system of FIG. 1;

FIG. 10 is a detailed cross-sectional view of an extrusion assembly and cooling system of an exemplary edible food product printer system of FIG. 1;

FIG. 11 is a detailed cross-sectional view of an extrusion assembly of an exemplary edible food product printer system of FIG. 1;

FIG. 12 is a detailed perspective view of a cooling shroud of an exemplary edible food product printer system of FIG. 1;

FIG. 13 is a front view of a cartridge of an exemplary edible food product printer system of FIG. 1;

FIG. 14 is a perspective view of an extrusion assembly and cartridge of an exemplary edible food product printer system of FIG. 1;

FIG. 15 is a detailed perspective view of an extrusion assembly of an exemplary edible food product printer system of FIG. 1 during an extrusion process;

FIG. 16 is a detailed front view of an extrusion assembly and cooling system of an exemplary edible food product printer system of FIG. 1;

FIG. 17 is a detailed perspective view of an extrusion assembly and cooling system of an exemplary edible food product printer system of FIG. 1;

FIG. 18 is a perspective view of a heating system usable in combination with an exemplary edible food product printer system of FIG. 1;

FIG. 19 is a block diagram of an exemplary edible food product printer system of the present disclosure;

FIG. 20 is a front view of an exemplary edible food product printer system of the present disclosure;

FIG. 21 is a perspective view of an exemplary edible food product printer system of FIG. 20 with a door and windows removed for clarity;

FIG. 22 a top view of an exemplary edible food product printer system of FIG. 20 with a window removed for clarity;

FIG. 23 is a front perspective view of an exemplary edible food product printer system of FIG. 20 with housing walls partially removed for clarity;

FIG. 24 is a front view of an exemplary edible food product printer system of FIG. 20 with housing walls partially removed for clarity;

FIG. 25 is a side view of an exemplary edible food product printer system of FIG. 20 with housing walls partially removed for clarity;

FIG. 26 is a perspective view of an exemplary edible food product printer system of FIG. 20 with housing walls partially removed for clarity;

FIG. 27 is a top view of a translation system for an extrusion assembly of an exemplary edible food product printer system of FIG. 20 with housing walls removed for clarity;

FIG. 28 is a detailed top view of a translation system for an extrusion assembly of an exemplary edible food product printer system of FIG. 20 with housing walls removed for clarity;

FIG. 29 is a perspective view of a cartridge of an exemplary edible food product printer system of FIG. 20;

FIG. 30 is a side view of a cartridge of an exemplary edible food product printer system of FIG. 20;

FIG. 31 is a cross-sectional view of a cartridge of an exemplary edible food product printer system of FIG. 20;

FIG. 32 is a front view of an extrusion assembly of an exemplary edible food product printer system of FIG. 20; and

FIG. 33 is a cross-sectional view of an extrusion assembly of an exemplary edible food product printer system of FIG. 20.

### DETAILED DESCRIPTION

Various terms relating to the systems, methods and other aspects of the present disclosure are used throughout the specification and claims. Such terms are to be given their ordinary meaning in the art unless otherwise indicated. Other specifically defined terms are to be construed in a manner consistent with the definition provided herein.

As used in this specification and the appended claims, the singular forms “a,” “an,” and “the” include plural referents unless the content clearly dictates otherwise.

The term “more than 2” as used herein is defined as any whole integer greater than the number two, e.g., 3, 4, or 5.

The term “plurality” as used herein is defined as any amount or number greater or more than 1. In some embodiments, the term “plurality” means 2, 3, 4, 5, 6 or more.

The terms “left” or “right” are used herein as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes.

The terms “substantially horizontal” or “substantially vertical” are used herein when referring to a relationship relative to a horizontal axis or plane or a vertical axis or plane, respectively. In some embodiments, “substantially horizontal” refers to equal to 0° from horizontal, or ±10°, ±5°, ±1°, ±0.5°, ±0.4°, ±0.3°, ±0.2°, ±0.1°, ±0.09°, ±0.08°, ±0.07°, ±0.06°, ±0.05°, ±0.04°, ±0.03°, ±0.02° or ±0.01° from horizontal. In some embodiments, “substantially vertical” refers to equal to 0° from vertical (e.g., a vertical plane perpendicular to horizontal), or ±10°, ±5°, ±1°, ±0.5°, ±0.4°, ±0.3°, ±0.2°, ±0.1°, ±0.09°, ±0.08°, ±0.07°, ±0.06°, ±0.05°, ±0.04°, ±0.03°, ±0.02° or ±0.01° from vertical.

The term “about” or “approximately” as used herein when referring to a measurable value such as an amount, a temporal duration, and the like, is meant to encompass variations of ±20%, ±10%, ±5%, ±1%, ±0.5%, ±0.4%, ±0.3%, ±0.2%, ±0.1%, ±0.09%, ±0.08%, ±0.07%, ±0.06%, ±0.05%, ±0.04%, ±0.03%, ±0.02% or ±0.01% from the specified value, as such variations are appropriate to perform the disclosed methods.

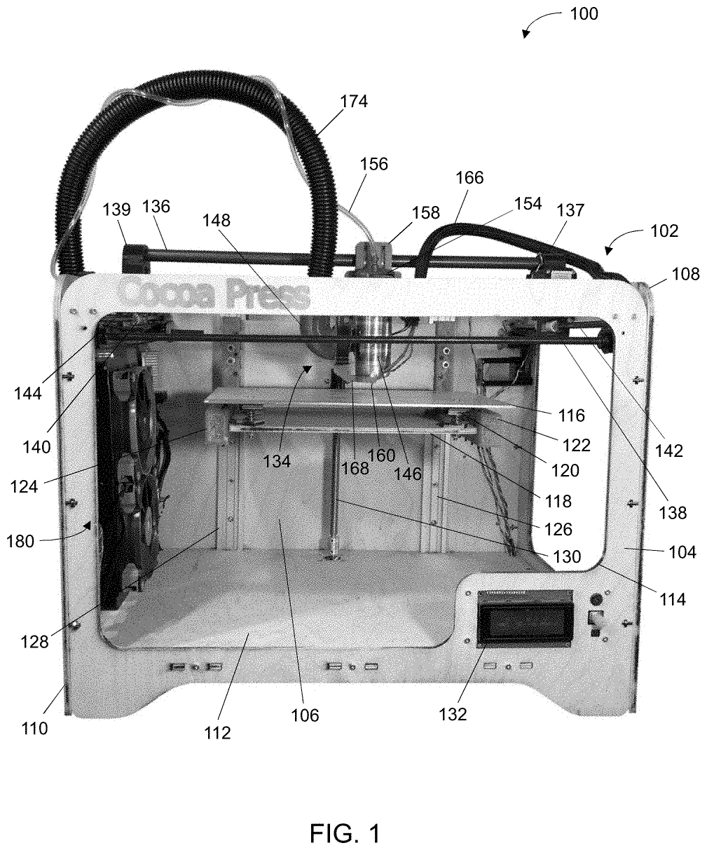

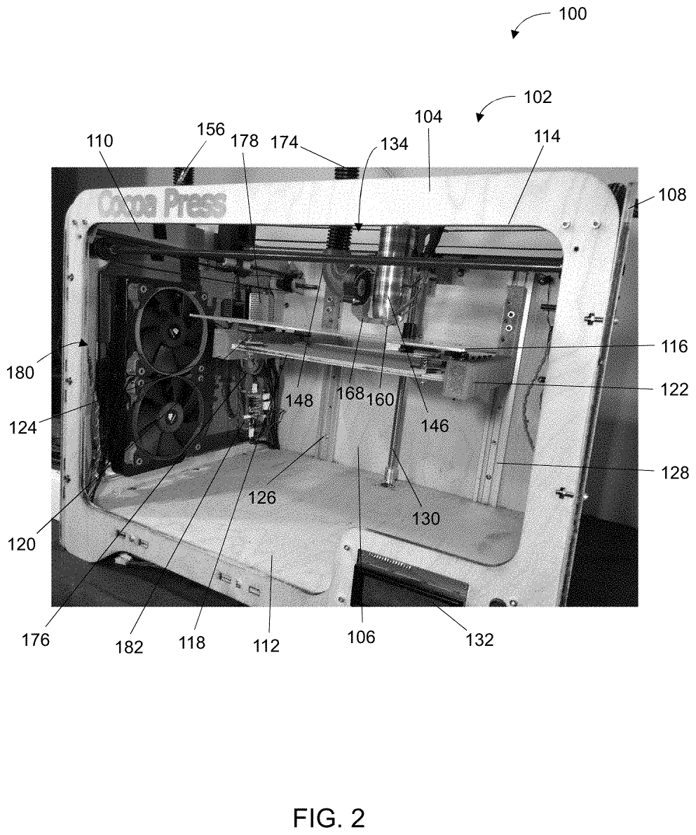

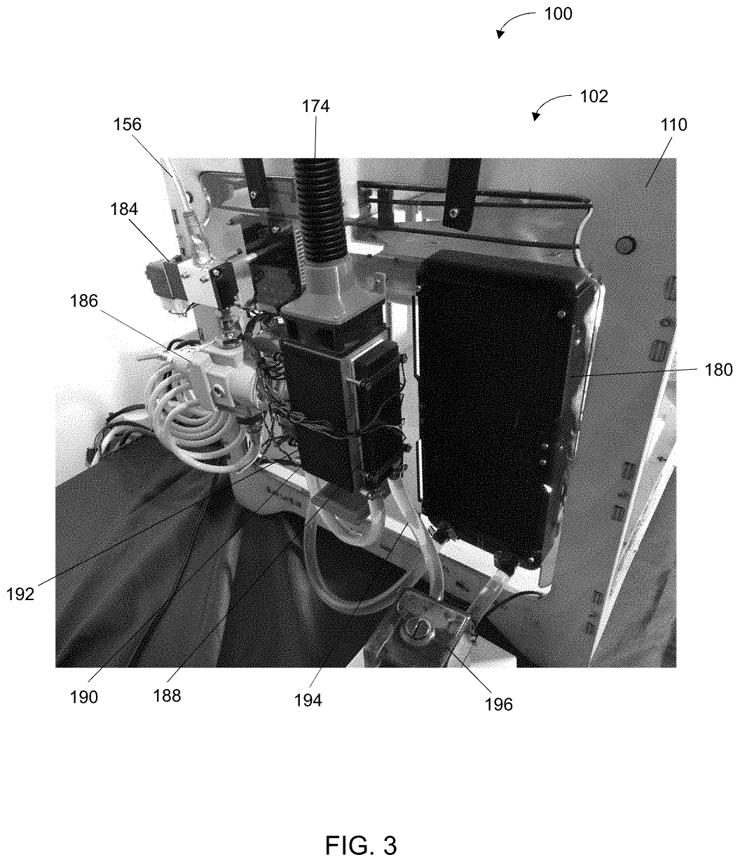

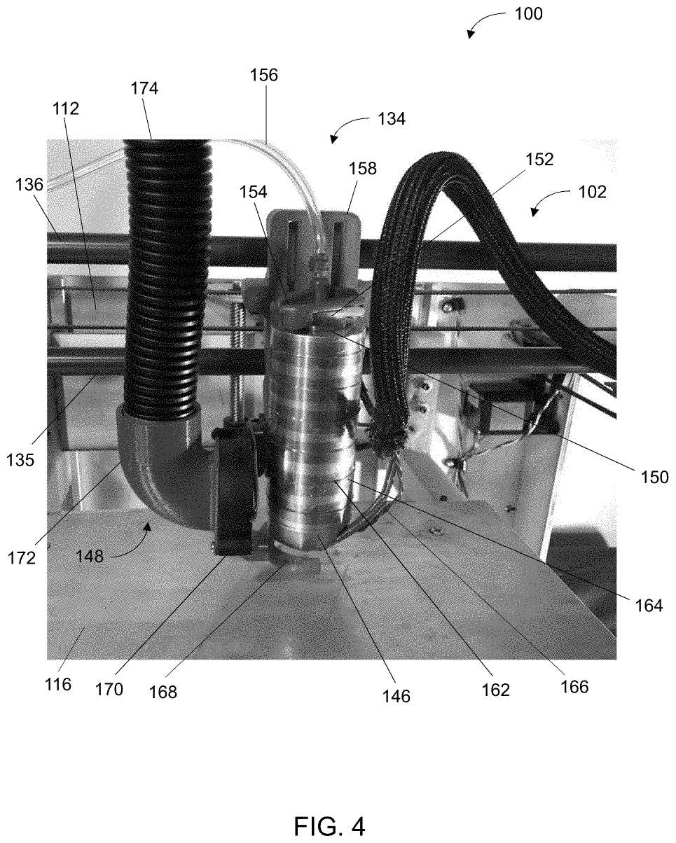

FIGS. 1-4 are front, perspective and detailed views of an exemplary edible food product printer system 100 (hereinafter “system 100”) of the present disclosure. Although discussed herein as implemented with chocolate, it should be understood that any type of edible food product capable of being at least partially melted can be used with the system 100, e.g., milk chocolate, dark chocolate, white chocolate, butter, cheese, caramel, combinations thereof, or the like. In some embodiments, the system 100 can be used to print with ice. It should be understood that the type of product or chocolate used may affect the time for melting. In addition, the system 100 can be used with food products that do not need to be heated, e.g., icing, mashed potatoes, marzipan, honey, guacamole, hummus, cookie dough, pureed food (e.g., food puree), food paste, combinations thereof, or the like.

As will be discussed herein, the system 100 can receive solid chocolate (e.g., callets, chips, chunks, or the like), heats the chocolate to a predetermined temperature or temperature range to melt the chocolate, and uses compressed air in a pneumatic system to extrude the chocolate onto a build plate. In some embodiments, a protective sheet (e.g., parchment paper, or the like) can be placed on top of the build plate for extrusion onto the sheet for ease of removability and hygiene. In some embodiments, rather than the protective sheet, a food-safe, washable, semi-rigid sheet material can be used on top of or as part of the build plate (e.g., steel, silicone and/or plastic sheet). Simultaneously to extrusion of the chocolate, a cooling system reduces the temperature of the extruded chocolate to ensure the structural integrity of the extruded chocolate. Particularly, simultaneous cooling of the extruded chocolate allows for printing of tall three-dimensional structures (e.g., six inches or higher) while maintaining the structural integrity of the material.

The exemplary system 100 provides for three-dimensional printing of chocolate capable of reaching heights greater than traditional printers (e.g., approximately 3 inches or greater in height, approximately 5 inches or greater in height, approximately 6 inches or greater in height, or the like, relative to the build plate). In some embodiments, the system 100 can have a build volume of about 8 inches in length, about 8 inches in width, and about 6 inches in height. The system 100 includes a user interface capable of receiving as input a three-dimensional model file, with the system 100 printing a physical chocolate structure corresponding with the three-dimensional model. In some embodiments, the user interface can be used to scan any object (e.g., the head of a person), generate a corresponding three-dimensional model, and the system 100 outputs a three-dimensional extruded structure representative of the three-dimensional model. Customizable, three-dimensional extruded items can therefore be printed.

Still with reference to FIGS. 1-4, the system 100 includes a housing 102 including a front wall 104, a rear wall 106, side walls 108, 110, a bottom wall 112, and a top wall (not visible). One or more of the walls can include a window or cutout 114 through which the three-dimensional process can be viewed. The cutout 114 can include a transparent glass or PLEXIGLASS™ such that the walls form a substantially sealed enclosure within the housing 102. The sealed enclosure allows for a cooling system to maintain the temperature within the walls of the housing 102, ensuring controlled cooling and hardening of the extruded chocolate.

The system 100 includes a build plate 116 forming a substantially flat or planar structure. The build plate 116 can be oriented substantially parallel to horizontal. In some embodiments, the three-dimensional structure can be printed directly on the build plate 116 with the build plate 116 defining a sterile or food grade surface. In some embodiments, the build plate 116 can be disengageable from the system 100 such that the build plate 116 and printed structure can be removed from the system 100. In some embodiments, a protective sheet (e.g., parchment paper, or the like) can be placed on top of the build plate 116 for extrusion onto the sheet for ease of removability and hygiene. The protective sheet can be replaced after completion of each three-dimensional product. Fasteners (e.g., magnets or clips) can be used to maintain the position of the protective sheet on the build plate 116 during the extrusion process.

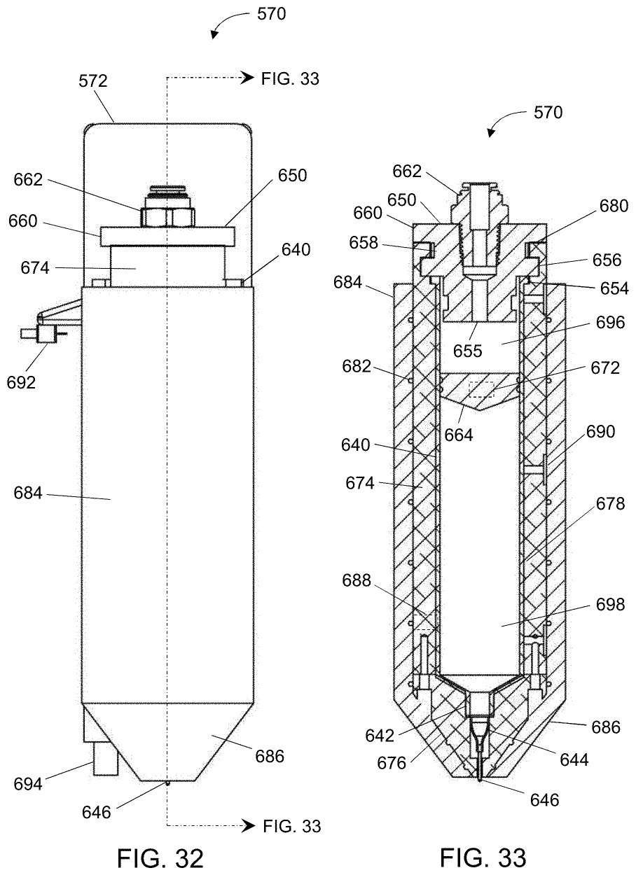

In some embodiments, the build plate 116 can be fabricated from, e.g., aluminum, stainless steel, glass, or the like, assisting in cooling of the first extruded layer of chocolate. The build plate 116 can be mounted to a translation plate 118 disposed below the build plate 116. The translation plate 118 can also define a substantially flat or planar structure oriented substantially parallel to horizontal and the build plate 116. In some embodiments, two or more leveling screws 120 and springs can adjustably couple the bottom of the build plate 116 to the top of the translation plate 118. The distance or height between the build plate 116 and translation plate 118 can be customized or adjusted at each of the respective positions by actuation of the leveling screws 120 (e.g., extending or retracting the leveling screw 120). The substantially horizontal orientation of the build plate 116 can be achieved using the leveling screws 120 prior to the printing process. In some embodiments, an inductive probe (e.g., probe 694 of FIG. 32) can be used to ensure a level position of the build plate 116.

Side slide members 122, 124 can be coupled to opposing sides of the translation plate 118, with the rear end of the respective slide members 122, 124 slidably coupled to a track 126, 128 at the rear wall 106 of the housing 102. In some embodiments, a translation mechanism 130 (e.g., a helical screw, or the like) can be mounted to the bottom of the translation plate 118. A controller 132 can actuate rotation of the translation mechanism 130 to slide the members 122, 124 along the respective tracks 126, 128. Translation of the plate 118 along a vertical axis simultaneously adjusts the vertical positioning of the build plate 116. Such adjustment can be performed before the printing process initiates and automatically during the printing process. For example, the initial vertical position of the build plate 116 can be selected prior to printing on the build plate 116. Subsequently, as each layer of chocolate is printed onto the build plate 116 and the extruded layers of chocolate, the build plate 116 can be automatically gradually/incrementally translated downwardly to accommodate the next layer of chocolate to be extruded. In some embodiments, the build plate 116 can remain at the same height or elevation, and an extrusion assembly 134 can be moved upwards relative to the build plate 116 to accommodate the next layer of chocolate to be extruded.

The system 100 includes the extrusion assembly 134 movably coupled within the housing 102. The extrusion assembly 134 can be mounted to a translation system capable of moving the extrusion assembly 134 along the x and y axes. In some embodiments, the translation system can move the extrusion assembly 134 along the z axis. The translation system includes linear bars 135, 136 (e.g., bottom and top bars extending substantially parallel to horizontal) with support flanges 137, 139 coupled on opposing sides of the bars 135, 136 and coupling the bars 135, 136 together. The use of two bars 135, 136 ensures the vertical alignment of the extrusion assembly 134 with the build plate 116. The support flanges 137, 139 are movably mounted to bearings 138, 140 slidable along side bars 142, 144. The side bars 142, 144 can extend substantially perpendicularly relative to the bars 135, 136. The extrusion assembly 134 can be slidably translated along the bars 135, 136 to move along the x-axis, and the bars 135, 136 can be slidably translated along the side bars 142, 144 to move the extrusion assembly 134 along the y-axis. The position of the extrusion assembly 134 relative to the build plate 116 can thereby be adjusted manually or in an automated manner prior to, during, and after the printing process.

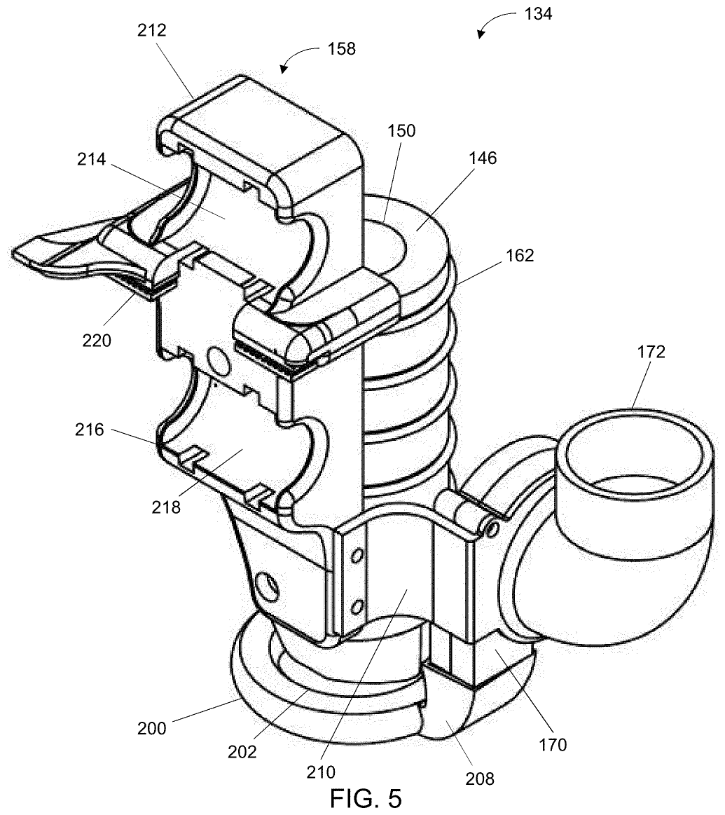

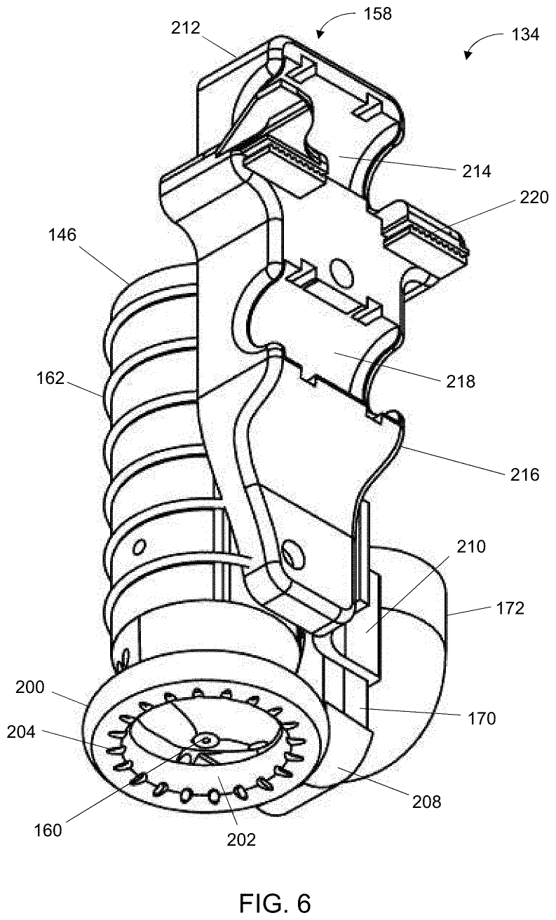

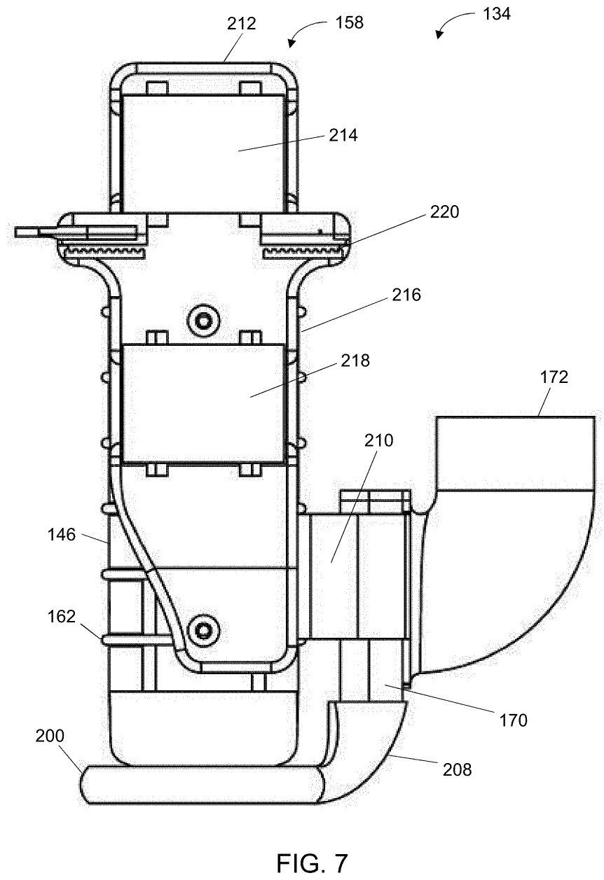

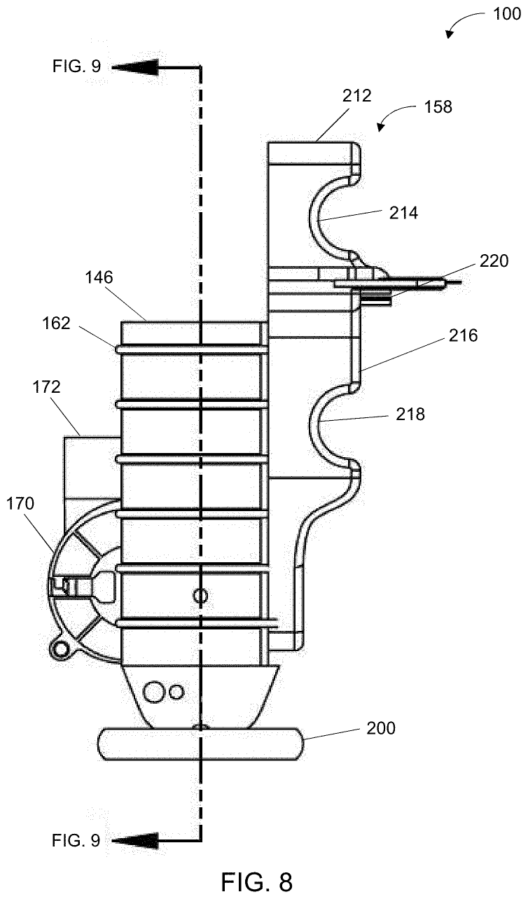

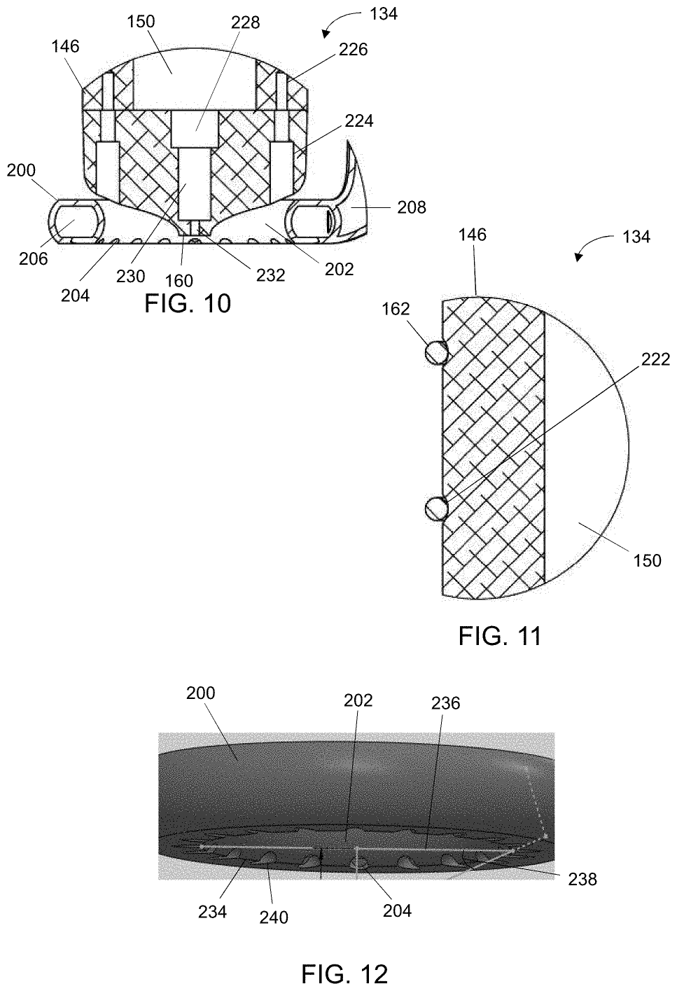

With reference to FIGS. 5-14, the extrusion assembly 134 includes a heating chamber 146 configured to heat and melt the chocolate inserted into the heating chamber 146, and a cooling system 148 for cooling the extruded or printed chocolate. The heating chamber 146 defines a substantially cylindrical configuration and can be fabricated from, e.g., aluminum, stainless steel, or the like, to allow for efficient heating. The heating chamber 146 includes a central bore 150 configured to receive therein a cartridge 152 containing partially melted or unmelted chocolate (e.g., tempered chocolate, untampered chocolate, chocolate chips, combinations thereof, or the like). In some embodiments, the cartridge 152 can be filled with tempered chocolate and allowed to cool, allowing for future use of the prefilled cartridge 152. In some embodiments, the cartridge 152 can be fabricated from a plastic material capable of being heated to melt the chocolate. In some embodiments, one or more portions of the cartridge 152 can be fabricated from a food grade material to ensure safety of the printed product, and to allow for more efficient cleaning of the cartridge 152 for subsequent use. The cartridge 152 can be press fit into the central bore 150, with the position of the cartridge 152 maintained via friction. Thus, assembly of the cartridge 152 with the heating chamber 146 can be performed without fasteners.

The cartridge 152 can include an adapter 154 secured to the top section of the cartridge 152. The adapter 154 can be fluidically connected to a tube 156 leading to a pressurized air source. As will be discussed in greater detail below, pressurized air can be introduced into the cartridge 152 from the tube 156 to extrude the melted chocolate from the heating chamber 146. In some embodiments, the pressurized air can be introduced into the cartridge 152 to be in direct contact with the chocolate, the pressure from the air imparting a force on the chocolate for extrusion from the cartridge 152. In some embodiments, a plunger can be disposed within the cartridge 152 with the pressurized air imparting a force on the plunger to extrude the chocolate (e.g., the pressurized air is in direct contact with the plunger, not the chocolate). The use of pressurized air to actuate extrusion results in an accurate, efficient and substantially continuous extrusion of the chocolate. The use of pressurized air also reduces the number of moving parts that may require maintenance over time (e.g., as compared to stepper motor operation). The use of pressurized air also allows the system 100 to disregard the presence of air bubbles in the cartridge 152. Particularly, using pressurized air allows the cartridge 152 to be at the correct/desired pressure immediately upon use without any delay to pressurize the air due to differing amounts of air in the cartridge 152 (as is generally needed when using a stepper motor). An x-axis carriage 158 can couple the heating chamber 146 to the top bar 136 to allow for translation of the extrusion assembly 134 along the top bar 136.

The central bore 150 extends from the top surface downwardly into the body of the heating chamber 146. The bottom section of the heating chamber 146 includes a nozzle 160 with a central opening configured to receive therethrough a portion of a luer lock tip of the cartridge 152. An elongated heating element 162 (e.g., resistive wire, nichrome wire, cupronickel (CuNi) alloy, PTC rubber, or the like) can be continuously and concentrically wound around and secured to the outer surface of the heating chamber 146. In some embodiments, tape 164 (e.g., yellow KAPTON® tape, high temperature rated insulating tape, or the like) can be used to secure the element 162 to the outer surface of the heating chamber 146. In some embodiments, a layer of insulation can be placed around the heating chamber 146 to assist in maintaining the temperature of the material and to secure the element 162 to the outer surface of the heating chamber 146. The tape 164 can be placed above and below the heating element 162 to separate the vertically spaced layers of the heating element 162, thereby preventing shorting of the heating element 162 across the cartridge 152. Each coil of the heating element 162 can be evenly spaced along a vertical axis to ensure even heating of the chocolate within the heating chamber 146. The spacing between each coil of the heating element 162 can be selected based on the material of the heating chamber 146 to ensure even and efficient heating of the chocolate within the heating chamber 146.

One end of the heating element 162 can be coupled to wiring 166 connected to an energy source to energize and heat the heating element 162 to a predetermined temperature or temperature range. In some embodiments, the heating element 162 can be used to heat and maintain the heating chamber 146 at a range from about 30° C. to about 32° C. Such temperature range allows the chocolate to be heated slowly without burning, providing for a tempering effect that results in the cooled chocolate having the preferred crystallization structure (e.g., 4^{th} crystallization stage, 5^{th} crystallization stage, or the like). In some embodiments, the chocolate being heating in the heating element 162 has the desired crystal structure prior to heating and heating the chocolate to the noted temperature range ensures that the crystal structure remains unchanged during heating. In some embodiments, the time to reach the noted temperature range can be between about 30 minutes to about 45 minutes. The slow heating and rise from ambient conditions to the noted temperature range results in a melted chocolate that has the desired properties for printing. In some embodiments, a mixing element can be disposed within the cartridge 152 to mix the chocolate during the melting process in a continuous manner or at predetermined intervals.

In some embodiments, the system 100 can include a capacitive sensor and/or a magnet to detect when the chocolate has run out in the cartridge 152. For example, if a plunger is disposed within the cartridge 152, the plunger can include a magnet and the heating chamber 146 can include one or more sensors to detect the position of the magnet when the plunger reaches predetermined positions within the heating chamber 146. In some embodiments, the system 100 can automatically pause the extrusion process to allow for switching of the cartridges 152. In such instances, the heating chamber 146 can be replaced with a heating chamber 146 having premelted chocolate or a new cartridge 152 can be introduced into the heating chamber 146 for melting the chocolate and continuing the printing process. Such cartridge 152 switching operation can be performed for printing requiring more than 30 cc of chocolate. In some embodiments, the cartridge 152 can be a 30 cc cartridge, a 50 cc cartridge, or a 60 cc cartridge.

The cooling system 148 includes a cooling shroud 168 disposed at least partially around the nozzle 160 of the heating chamber 146. In some embodiments, the cooling shroud 168 can encircle the nozzle 160 by approximately 180 degrees. In such embodiments, the cooling shroud 168 can form a substantially semicircular configuration having an arched structure. In some embodiments, the cooling shroud 168 can encircle the nozzle 160 by approximately 180 to 360 degrees. In some embodiments, the cooling shroud 168 can encircle the nozzle 160 by approximately 360 degrees. In such embodiments, the cooling shroud 168 can form a substantially cylindrical configuration with the nozzle 160 extending through the central opening of the cooling shroud 168.

The cooling shroud 168 includes a plurality of radial openings formed therein and fluidically connected to an interior passage of the cooling shroud 168 such that cold air can be passed through the radial openings and onto the extruded chocolate. The cooling system 148 includes a radial fan 170 fluidically coupled to the cooling shroud 168, a connector 172 (e.g., elbow) fluidically coupled to the radial fan 170, and a tube 174 fluidically coupled to the connector 172 to form a passage of cold air to be expelled from the cooling shroud 168.

In some embodiments, the cold air provided by the cooling system 148 can be in the range from, e.g., about 45° F. to about 65° F., about 50° F. to about 60° F., or the like. In some embodiments, when using the cooling shroud 168, the temperature of the cold air provided by the cooling system 148 can be in the range from about 45° F. to about 55° F. In some embodiments, when providing cold air to the entire enclosure of the system 100, the cold air can be in the range from, e.g., about 50° F. to about 60° F., about 55° F. to about 60° F., or the like. In some embodiments, the system 100 can be placed in a cold room such that the surrounding environment is at the desired temperature for cooling the printed chocolate, and the cooling system 148 can be optional. In some embodiments, the cooling system 148 can draw air from the surrounding, cooled environment rather than from dedicated cooling elements.

The system 100 includes an air pressure gauge 176 for measuring and monitoring the pressure within the tube 156 for the cartridge 152. An electric circuit 182 can be used to convert peak waves (e.g., input to a stepper motor driver) to square waves to drive a pneumatic solenoid valve 184. The solenoid valve 184 can be used to direct pressure into the cartridge 152 from a compressor and pressure regulator to extrude the melted chocolate. The solenoid valve 184 can be a three-way valve such that when on, pressurized air is connected to the cartridge 152. When the solenoid valve 184 is in the off position, the cartridge 152 can be connected to atmospheric air. Such operation allows the system 100 to stop extruding melted chocolate almost immediately when it is no longer necessary, and ties the command to disconnect the pressurized air and relieve the pressure in the cartridge 152 into a single mechanical part. In addition, the pneumatic actuation system provides for precise extrusion of the chocolate, allowing for a specific pressure to be used and/or adjusted depending on the type of chocolate being used. In some embodiments, the electric circuit 182 can use an LM 555 timer IC. For example, the system can be used to convert the peak waves for the stepper motor driver into square waves for the solenoid valve 184. Any time the peak of the peak wave occurs, the circuit inverts the signal such that the peaks are ground. This triggers the LM 555 timer to produce a square wave for an amount of time set by resistors and/or capacitors and an adjustable potentiometer. The amount of time has a duty cycle high enough that the solenoid valve 184 reads the cycle as an “on” signal (as opposed to quickly turning on and off). The solenoid valve 184 remains open until the peak of the peal wave stops. The system 100 includes a mosfet or heatsink 178 to power the cooling system 148, and one or more radiator fans 180 to assist in operating the cooling system 148.

The system 100 includes an air pressure regulator 186 for introducing air into the pressurized air tube 156. In some embodiments, the regulator 186 can be set to, e.g., approximately 15 to 30 psi, approximately 15 to 25 psi, approximately 15 to 20 psi, or the like. In some embodiments, the pressure used can be based on the type of material being used for printing. For example, a pressure of about 15 psi can be used for white chocolate, a pressure of about 20 psi or 25 psi can be used for milk chocolate, and a pressure of about 30 psi can be used for darker chocolate with less cocoa butter. The cooling system 148 includes six thermoelectric cooling devices 188 (e.g., Peltier devices, or the like) for providing cold air to the shroud 168. In some embodiments, three devices 188 can be mounted on each side of a housing 190. One or more insulated aluminum heat sinks 192 can be mounted to the housing 190 for the cold side of the devices 188. A water cooling loop 194 can be coupled between the devices 188 and a water pump 196, with the water pump 196 further coupled to the radiator fans 180.

In some embodiments, a signal can be sent to turn on the cooling system 148 from an Arduiono/RAMPS shield. In some embodiments, an MKS Gen L board can be used. The mosfet or heatsink 178 provides power for the Peltier devices and the circuit 182 has smaller mosfets to power the two radiator fans and water pump. The Peltier devices become hot on the outside and cold on the inside. The inside of all of the Peltier devices is connected to respective aluminum heatsinks that have air blown through them to cool the air down. The first fan can be directly above the aluminum heatsinks. The fan type can pull air from behind it, without outgoing air being turbulent in nature. The air travels through the tube 174 to another radial fan. The radial fan can be used to direct air going away from the fan. The hot side of the Peltier devices can be connected to a water cooling loop. The water pump 196 pushes water into the radiator to cool it down. The now cool water travels to the first aluminum block that is thermally connected to the hot side of the Peltier devices. This is further connected in series to another aluminum heatsink. The now warm water travels back to the pump 196 (where any bubbles that may be in the system rise to the top of the reservoir for the pump 196), and is cooled down by the radiator.

In addition to cooling the extruded chocolate, the cold air from the shroud 168 can cool the build plate 116 and the environment surrounding the build plate 116. In some embodiments, rather than or in addition to Peltier devices, the system 100 can include a cooling system (e.g., an air conditioning system) with compressed refrigerant to maintain a predetermined temperature within the enclosure of the housing 102. Thus, rather than focusing cold air only on the chocolate and the surrounding structures, the system 100 can include a cooling system that maintains the overall environment surrounding the build plate 116 at a desired temperature.

FIGS. 5-11 show perspective, rear, right side, cross-sectional and detailed views of the extrusion assembly 134 of the system 100. Rather than including a semicircular cooling shroud, the cooling system includes a round or circular cooling shroud 200 (e.g., 360°) configured to completely surround the nozzle 160 of the heating chamber 146. The circular shroud 200 allows for less airflow per opening 204, reducing the force exerted by the air on the chocolate and reducing deflection of such chocolate during printing and cooling. The cooling shroud 200 includes a central opening 202 with a plurality of radial openings 204 formed on the inner surfaces of the cooling shroud 200. The openings 204 can be inwardly directed towards each other and angled at approximately 20 degrees downwardly relative to horizontal to downwardly expel air onto the extruded chocolate.

As shown in FIG. 10, the cooling shroud 200 includes a hollow interior passage 206 through which cold air can be directed through the openings 204 and onto the extruded chocolate. The cooling system can include a connector 208 coupled to the radial fan 170, and the radial fan 170 can be coupled to a connector 172. The connectors 172, 208 include hollow interior passages that fluidically connect the cold air from the air source to the cooling shroud 200. A mounting flange 210 can couple the cooling system to carriage 158.

The carriage 158 can include a first section 212 with a semicircular cutout or track 214 and a second section 216 with a semicircular cutout or track 218 disposed below and spaced from the track 214. The tracks 214, 218 can be mated against and receive the linear bearings mounted to the respective bars 135, 136 of the translation system, allowing the extrusion assembly 134 to be moved along the x-axis. Connectors 220 can connect the carriage 158 to an x-axis belt

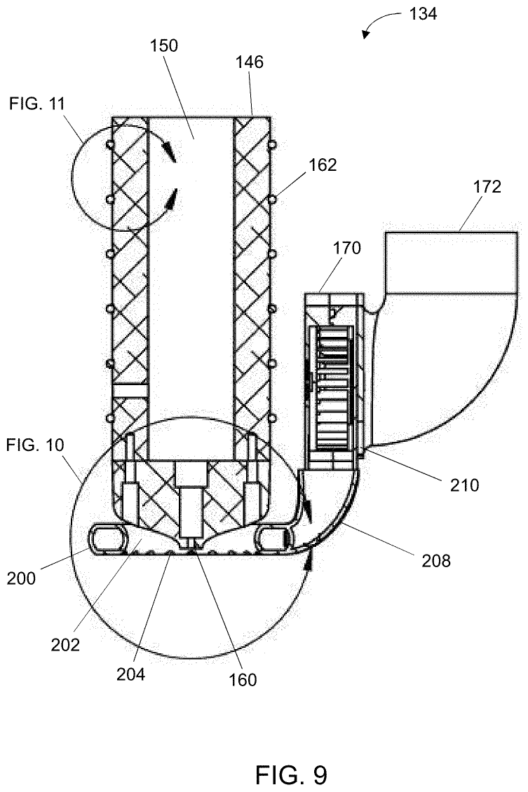

As shown in the cross-sectional and detailed views of FIGS. 9-11, the heating chamber 146 includes the heating element 162 wrapped around the outer surface of the heating chamber 146. In some embodiments, radial indentations, tracks or grooves 222 can be formed in the outer surface of the heating chamber 146 to receive the heating element 162. Such grooves 222 can guide assembly of the heating chamber 146 and ensure proper positioning and distribution of the heating element 162 along the height of the heating chamber 146 for substantially even heating of the chocolate. In embodiments including the radial grooves 222, tension in the heating element 162 wrapped around the heating chamber 146 can maintain the position of the heating element 162 without additional fastening elements.

In some embodiments, the nozzle 160 can be manufactured separately from the main body portion of the heating chamber 146, and fasteners (e.g., bolts) can be passed through complementary holes 224, 226 in the nozzle 160 and heating chamber 146 to couple said elements together. The nozzle 160 can initially define a cylindrical configuration, transition to a curved, convex structure, and taper to an endpoint at which extrusion of the chocolate occurs having a smaller diameter than the cylindrical section. Internally, the central bore 150 can extend the majority of the heating chamber 146 with reduction in the bore size within the nozzle 160. The nozzle 160 can include a first bore 228 having a diameter smaller than the diameter of the central bore 150, transitioning to a second bore 230 having a diameter smaller than the diameter of the first bore 228, and further transitioning to a third bore 232 having a diameter smaller than the diameter of the second bore 230. The first bore 228 can receive and mate with the luer lock tip of the cartridge 152, the second bore 230 can receive and mate with the plastic section of the luer lock tip, and the third bore 232 can receive the needle or tip of the luer lock tip. The third bore 232 can be sized such that different gauges of needles or tips can be used to allow for changes in resolution for prints.

FIG. 12 is a detailed view of the cooling shroud 200. The cooling shroud 200 can include an internal edge 234 extending radially and forming the transition between the central opening 202 at the interior portion of the cooling shroud 200 and the bottom surface of the cooling shroud 200. Each of the openings 204 can extend through the edge 234 such that a portion of the opening 204 is formed in the interior opening 202 and a portion of the opening 204 is formed in the bottom surface of the cooling shroud 200. Each of the openings 204 can be angled relative to horizontal 236 (e.g., a horizontal plane extending substantially parallel to the bottom surface of the cooling shroud 200). In some embodiments, the angle 238 of each opening 204 relative to horizontal 236 can be approximately 20°. The openings 204 can be angled such that the angle 238 and airflow is directed inwardly and intersects the bottom plane of the cooling shroud 200 (e.g., a plane parallel to horizontal 236). Such angled configuration ensures that the air is directed towards the nozzle 160 and below the nozzle 160 at the layer of chocolate recently printed.

In some embodiments, curved expanding walls 240 can surround each opening 204 to direct the airflow in an expansive manner towards the extruded chocolate. The expansion provided by the walls 240 allows more air to be focused on the printed chocolate, rather than on the nozzle 160. Such air distribution and guidance assists in solidifying the layer of extruded chocolate as a whole, even after the heating chamber 146 has moved on to printing a different section of the structure.

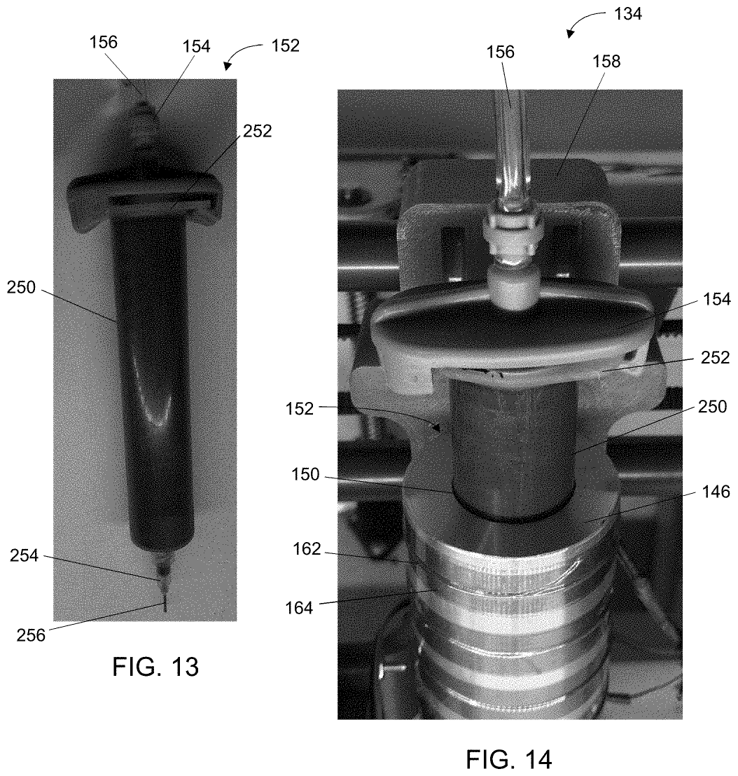

FIG. 13 is a front view of the cartridge 152. The cartridge 152 can define a substantially cylindrical, hollow main body portion 250 configured to receive, e.g., callets, chips, chunks, or the like, of solid chocolate. In some embodiments, the cartridge 152 can be prefilled with temperature chocolate. In some embodiments, the cartridge 152 can be in the form of a pneumatic syringe having the main body portion 250 and a top flange 252 extending therefrom. In some embodiments, the capacity of the cartridge 152 can be approximately 30 cc, 50 cc, or 60 cc. The adapter 154 can be coupled to the flange 252 and a portion of the adapter 154 can be inserted into the cartridge 152 such that compressed air can be introduced into the cartridge 152 via tube 156. The adapter 154 can be fabricated from a rubber material to create a seal within the cartridge 152, ensuring accurate introduction of pressurized air into the cartridge 152. In some embodiments, the pressurized air is introduced directly into the cartridge 152 and comes into direct contact with the chocolate. The pressurized air can thereby be used to progress the chocolate within the cartridge 152 without the use of a plunger. The cartridge 152 can include a luer lock tip 254 threaded onto the distal end of the body portion 250. The tip 254 can include a nozzle 256 through which the melted chocolate can be extruded.

FIG. 14 is a perspective view of the extrusion assembly 134 during loading of the cartridge 152 into the heating chamber 146. Chocolate can be loaded into the cartridge 152 and the cartridge 152 can be gradually inserted into the bore 150 of the heating chamber 146 until the flange 252 abuts or is positioned immediately adjacent to the top surface of the heating chamber 146. Friction between the cartridge 152 and heating chamber 146 maintains the inserted position of the cartridge 152 within the heating chamber 146. Upon insertion of the cartridge 152 into the heating chamber 146, the heating element 162 can be used to gradually heat the heating chamber 146 until the chocolate has melted.

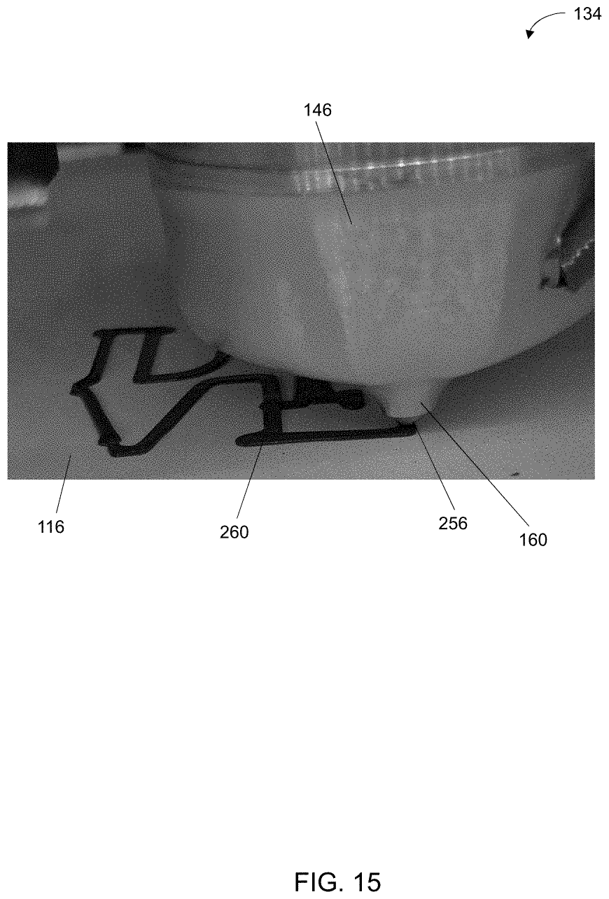

FIG. 15 is a detailed view of the extrusion assembly 134 during the three-dimensional printing or extrusion process. After the chocolate has been melted to the desired temperature within the heating chamber 146, pressurized air can be used to gradually extrude the chocolate in a controlled manner out of the nozzle 256. The chocolate can be extruded directly onto the build plate 116 or onto a protective sheet (e.g., parchment paper, or the like). As shown in FIG. 15, a first layer of the chocolate has been extruded onto the build plate 116. The position of the extrusion assembly 134 can be subsequently adjusted along the y-axis (and optionally the x-axis) to begin extrusion of the second layer of chocolate. Simultaneous to extrusion of the chocolate, cold air can be directed onto the extruded chocolate with the cooling shroud 168 (not shown for clarity) to ensure substantially immediate cooling of the chocolate on the build plate 116.

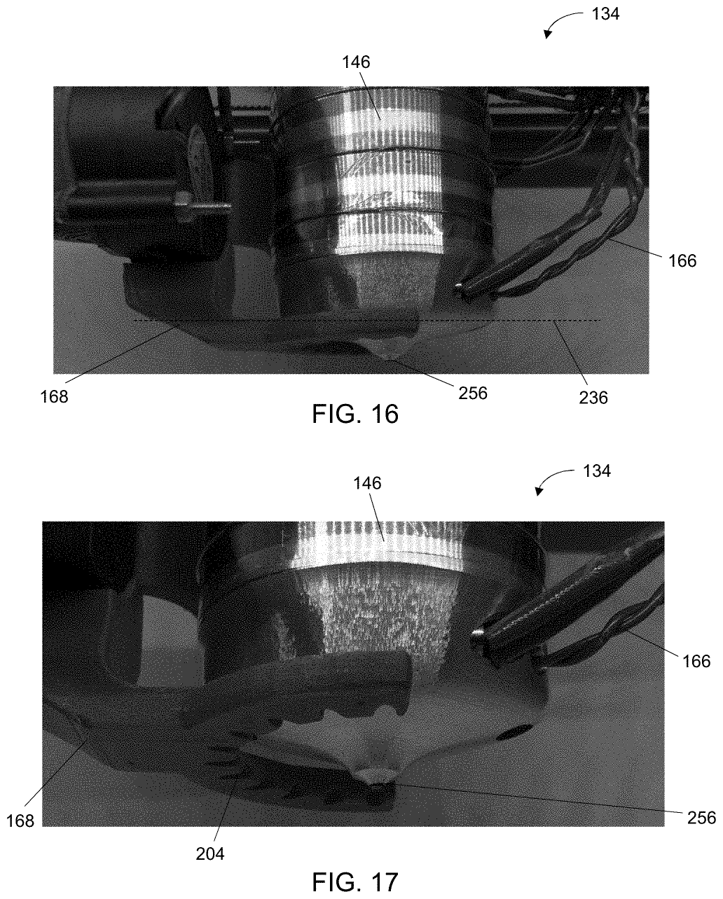

FIGS. 16 and 17 show detailed views of the extrusion assembly 134 with the cooling shroud 168. The body of the cooling shroud 168 can extend substantially parallel to horizontal 236 with the nozzle 256 extending below the cooling shroud 168. The openings 204 of the cooling shroud 168 are angled downwardly relative to horizontal 236 such that cold air expelled from the openings 204 is directed downwardly towards the extruded chocolate. In some embodiments, heating of the nozzle 160 and top, cylindrical section of the heating chamber 146 can be performed by a single heating source. In some embodiments, the system 100 can include a dual heating assembly with one set of wires 166 electrically coupled to the top, cylindrical section of the heating chamber 146 and another set of wires 166 electrically coupled to the nozzle 160 at the bottom of the heating chamber 146. Each of the sections can be independently controlled and actuated to heat and maintain the temperature of the chocolate. For example, if the nozzle 160 loses heat faster than the remaining section of the heating chamber 146 due to greater airflow onto the nozzle 160, the nozzle 160 can be independently heated to ensure the desired temperature of the chocolate is maintained. Such independent heating can assist in reduced or preventing clogging of the nozzle 160 during printing.

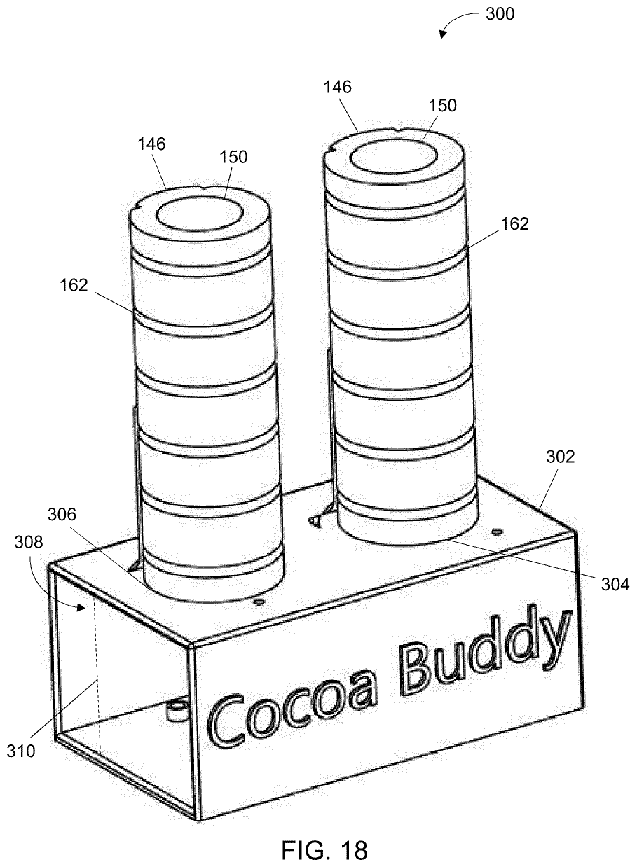

FIG. 18 is a perspective view of a heating system 300 configured to be used with the system 100. In some embodiments, the heating chamber 146 can receive the cartridge 152 and melt the chocolate while disposed above the build plate 116. In some embodiments, the heating chamber 146 can melt the chocolate prior to mounting above the build plate 116 using the heating system 300. In some embodiments, multiple cartridges 152 of chocolate can be heated using the heating system 300 in preparation for additional three-dimensional printing after chocolate in a first heating chamber 146 has been used.

The heating system 300 includes a base 302 with one or more cavities 304, 306 configured to receive the bottom section of a heating chamber 146. Each heating chamber 146 can receive a cartridge 152 with chocolate. Although shown as receiving two cartridges 152, the heating system 300 can be configured to receive one or more cartridges 152. The enclosure 308 within the base 302 includes internal electronics 310 that electronically connect with the heating element 162 to individually or simultaneously increase the temperature of the heating chamber 146, thereby melting chocolate disposed within the heating chamber 146. Upon melting the chocolate to the desired temperature, the heating system 300 can maintain the chocolate at the preset temperature until the heating chamber 146 is removed for use with the system 100. Efficient and substantially continuous printing of the chocolate can thereby be maintained by replacing an empty heating chamber 146 with a preheated heating chamber 146 from the system 300.

In some embodiments, each side of the heating system 300 can heat the chocolate to the desired temperature range (e.g., from about 30° C. to about 32° C.) with the cartridge 152 ready for use with the system 100. In some embodiments, one side of the heating system 300 can be used to heat and maintain the chocolate at a first temperature (e.g., approximately 28° C.), and the other side of the heating system 300 can be used to heat and maintain the chocolate at a second temperature (e.g., approximately 31° C., approximately 30° C. to approximately 32° C., or the like). A cartridge 152 can initially be heated to the first lower temperature, and move to the opposing side to heat to the second higher temperature. In some embodiments, the cartridge 152 can initially be heated to a first lower temperature by the heating system 300 and, upon transfer to the system 100, can be heated to the second higher temperature by the heating chamber 146. The chocolate can thereby be heated in stages. Such staggered heating can be beneficial in achieving the desired crystal structure of the chocolate.

In some embodiments, rather than or before using the heating system 300, the chocolate can be tempered in a separate system. For example, chocolate callets or chips can be tempered in a tempering machine (e.g., a ChocoVision automatic tempering machine) in batches at one time (e.g., 10 to 15, or more callets or chips). After tempering of the chocolate is completed, the tempered chocolate can be introduced into the cartridge 152 and allowed to cool. After the chocolate has cooled, the prefilled cartridges 152 are available for future use. For example, the prefilled cartridges 152 can be reheated using the heating system 300 or the heating chamber 146 of the system 100. The prefilled cartridges 152 provide for single use cartridges for ease of use and for food safety reasons. Thus, prefilled cartridges 152 can be provided for use with the system 100 having chocolate that has already been tempered to the desired level, with only reheating of the chocolate needed for the printing process. In some embodiments, the cartridges 152 can be cleansed, sanitized and reused after the printing process.

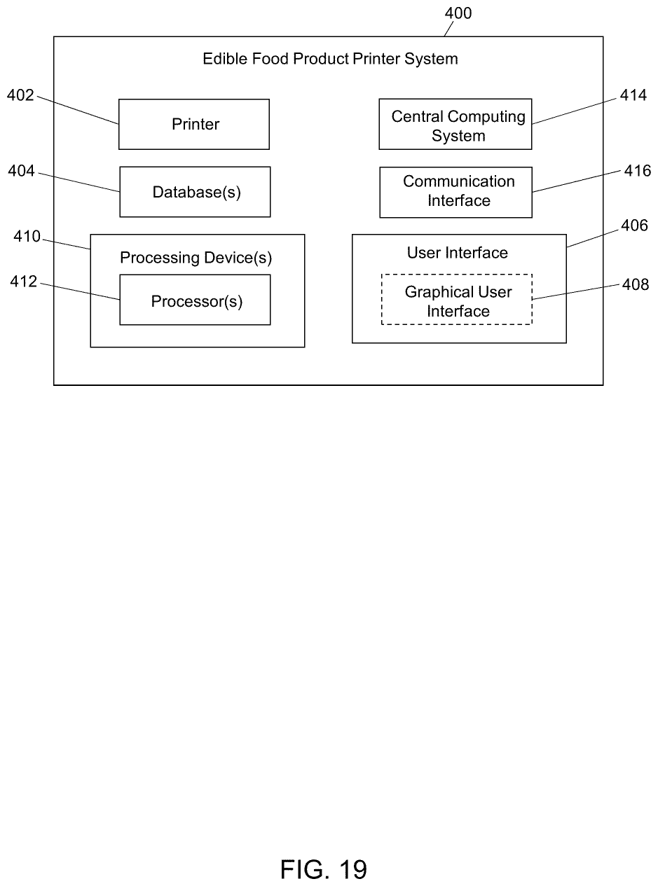

FIG. 19 is a block diagram of an exemplary edible food product printer system 400 (hereinafter “system 400”). The system 400 includes one or more components of the system 100. The system 400 includes a printer 402 (e.g., the three-dimensional printer of system 400), having the extrusion assembly, cooling system, or the like. The system 400 includes one or more databases 404 configured to electronically receive and store instructions regarding operation of the system 400, three-dimensional model files for printing the chocolate structure, and the like. The system 400 includes a user interface 406 with a graphical user interface 408 to receive as input instructions for operation of the system 400 and to output information regarding operation of the system 400.

The system 400 can include one or more processing devices 410 having one or more processors 412 for executing instructions to operate the system 400. The system 400 can include a central computing system 414 for receiving data, analyzing data/instructions, and instructing operation various components of the system 400. The system 400 can include a communication interface 416 for transmission of data and/or signals between various components of the system 400.

In operation, solid chocolate pieces can be placed within the cartridge 152. The cartridge 152 can be placed within the heating chamber 146 for heating. The heating chamber 146 can be gradually heated to approximately 30° C. to approximately 32° C. using the heating element 162 surrounding the heating chamber 146. After the chocolate has melted, a compressed air adapter 154 can be coupled to one end of the cartridge 152. The downmost position of the cartridge 152 within the heating chamber 146 can be ensured, with friction maintaining the position of the cartridge 152. Fasteners are therefore not needed for maintaining the position of the cartridge 152 within the heating chamber 146.

A three-dimensional model file (e.g., an .stl file from SOLIDWORKS®, or the like) can be provided as input to the system 100 via a user interface. In some embodiments, a computer can be electrically connected to the system 100 to provide input and receive output from the system 100. Based on the three-dimensional model file, the system 100 can print consecutive layers to form the three-dimensional structure. Internally, the system 100 can convert the three-dimensional printed model into layers for printing (e.g., slices of layers including layer height, printing speed, or the like). In some embodiments, the chocolate can be printed at a rate of approximately 10 mm/sec with a layer height of approximately 0.6385 mm and a nozzle of approximately 0.838 mm in diameter. In some embodiments, each layer height can be approximately 0.2 mm. In some embodiments, the layer height can be approximately ¾ of the size of the nozzle diameter. The print speed or rate can be scaled with the air pressure and can be dependent on the speed of cooling of the printed chocolate.

In some embodiments, CURA® can be used to slice the image file into layers to create a .gcode file, and PRONTERFACE® can be used to interface with a microcontroller of the printer. As the melted chocolate is extruded from the heating chamber 146, the cooling system (e.g., shroud 168) is actuated to direct cold air onto the chocolate to ensure the chocolate is cooled in a timely manner, resulting in a stronger structure. In some embodiments, the user interface can be used to control the printer, including settings such as temperature, cooling system, fans of the system, light emitting diodes, motor control, solenoid valve control, or the like. In some embodiments, the user interface can be used for calibration of the system 100, e.g., calibration of the offset from the tip of the nozzle to the build plate or bed.

During the printing process, a compressed air system can be used to gradually extrude chocolate from the heating chamber 146. A compressor coupled to a pressure regulator and a solenoid valve can be used to control the pressure of the pressurized air directed to the cartridge 152. In some embodiments, a particle filter and air dryer can be included in the system 100 to ensure a hygienic environment. The pressurized air provides for accurate control of the force exerted onto the chocolate, resulting in accurate extrusion of the chocolate. Particularly, rather than a stepper motor actuation that may have a long stop/start time, pressurized air can be used to extrude the chocolate in a more continuous manner. Air pressure provides a constant force while a stepper motor uses constant displacement. With imperfections (e.g., air bubbles in the printing material or compressibility of the system), using air pressure allows the pressure to equalize quickly during the printing process. The pressurized air ensures that the cartridge 152 is maintained at the correct/desired pressure, with no loss of time for pressurization due to air bubbles in the cartridge 152. The pressurized air further provides for faster stopping of the extrusion process. After the solenoid valve has been turned off (with the solenoid valve connecting the cartridge 152 to the pressurized air), extrusion is stopped and does not drip the chocolate. Stopping of a stepper motor and reversal of the motor direction to prevent dripping is therefore unnecessary in the system 100. The pressurized air allows for easier adjustment of the pressure applied to the chocolate during extrusion without the need for motor voltage adjustment. For example, the pressure used can be adjusted for different types of chocolate. The use of pressurized air also reduces the overall weight of the system 100 and the amount of maintenance needed. Particularly, the lack of an additional motor and track reduces the weight of the system 100 and on the cartridge 152, and reduces the number of mechanical parts near the chocolate, an impact on both the maintenance requirements and hygiene.

During the extrusion process, the solenoid valve can be in the on position such that pressurized air is connected to the cartridge 152. If extrusion is to be paused or stopped, the solenoid valve can be actuated into an off position and the cartridge 152 can be connected to atmospheric air. Such operation allows the system 100 to stop extruding melted chocolate almost immediately when it is no longer necessary, and ties the command to disconnect the pressurized air and relieve the pressure in the cartridge 152 into a single mechanical part. The overall operation of the system 100 allows for customized three-dimensional printing using edible food products (e.g., chocolate), including pressurized air for chocolate extrusion and a cooling system for extruded material cooling that ensure efficient and accurate operation of the system 100.

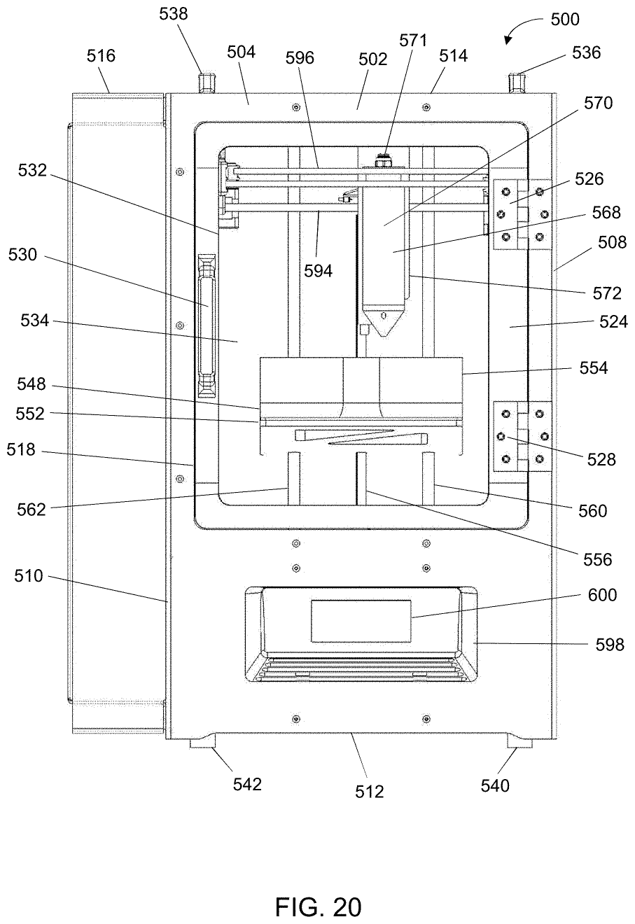

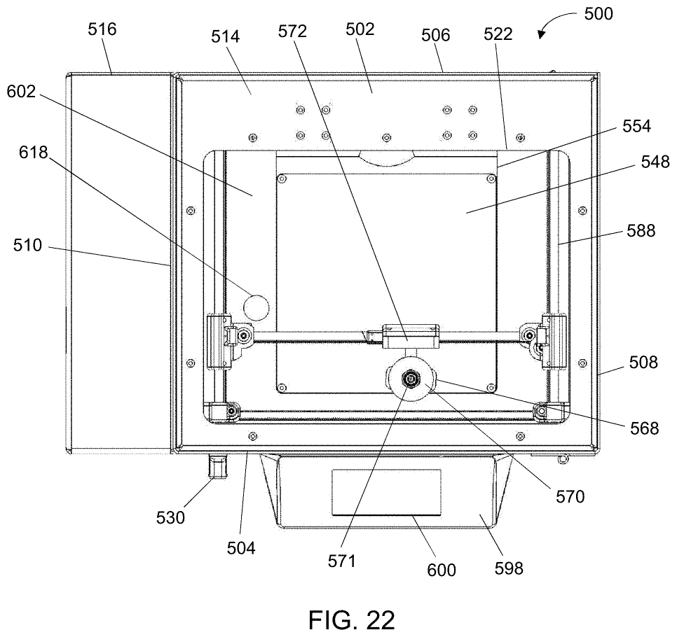

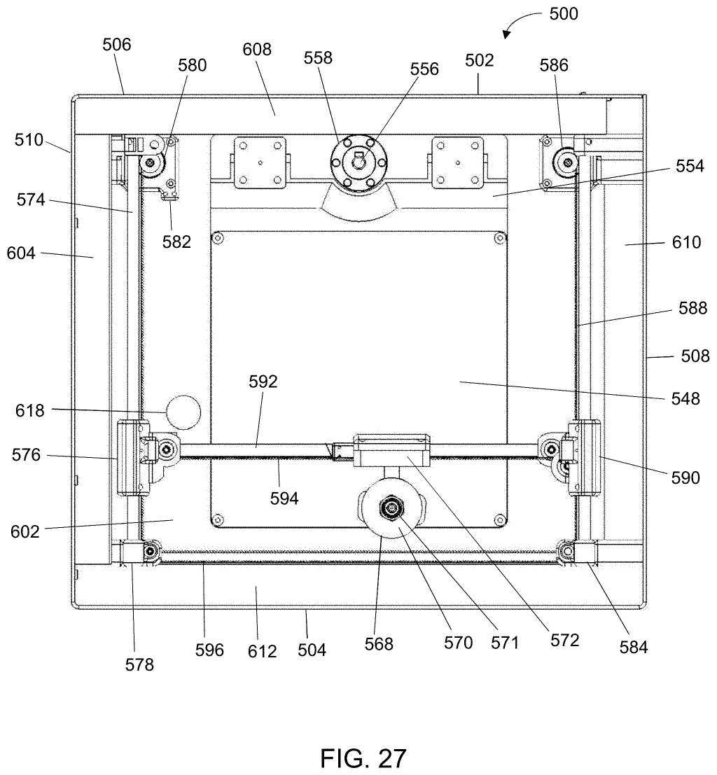

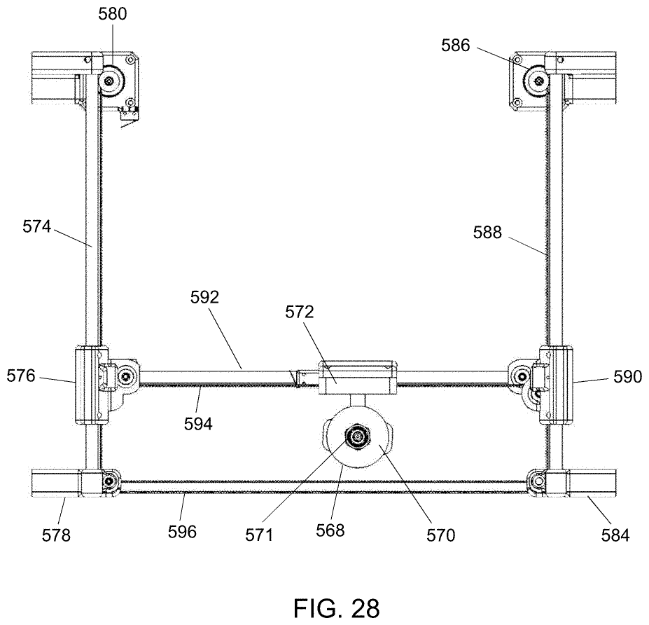

FIGS. 20-27 are front, perspective, top and side views of an exemplary edible food product printer system 500 (hereinafter “system 500”) of the present disclosure. The system 500 can be substantially similar in structure and function to the system 100, expect for the distinctions noted herein. As will be discussed in greater detail below, rather than a cooling shroud to cool the extruded chocolate, the system 500 includes a cooling system for cooling the entire chamber to a predetermined temperature, ensuring that the extruded chocolate will set as desired.

The system 500 includes a housing 502 including a front wall 504, a rear wall 506, side walls 508, 510, a bottom wall 512, and a top wall 514. The system 500 can include a separate enclosure 516 coupled to the side wall 510 for housing at least some electronics associated with the system 500. The system 500 includes multiple openings, windows or cutouts 518, 520, 522 in the housing 502 for visualizing the printing process within the housing 502. For example, the system 500 can include a cutout 518 in the front wall 504, a cutout 520 in the side wall 508, and a cutout 522 in the top wall 514. The system 500 includes a door 524 for covering the cutout 518.

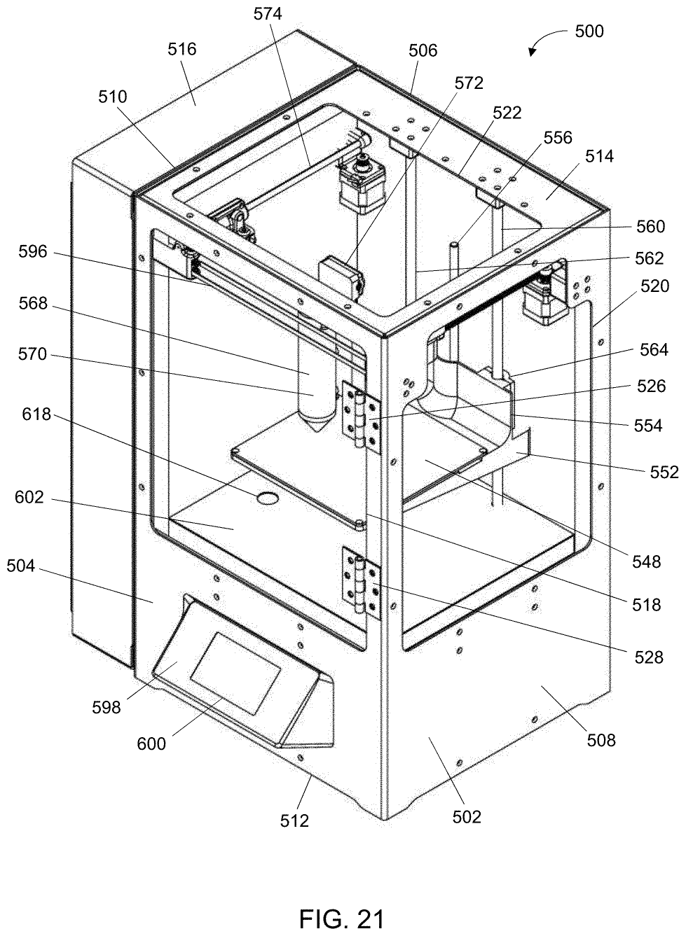

The door 524 can be hingedly coupled to the front wall 504 via hinges 526, 528 and includes a handle 530 for operating the door 524 between a closed and open position. The door 524 includes a cutout or opening 532 covered by a transparent window 534. The door 524 can be insulated and the window 534 can be formed from double-paned polycarbonate to prevent infiltration into the housing 502 and for maintaining the temperature within the housing 502. In some embodiments, an air gap of about 0.45 inches or about 0.5 inches can exist between the polycarbonate panes to assist in insulating the inner chamber. Although the other doors have been removed for clarity (e.g., only handles 536, 538 are visible in FIG. 21), it should be understood that the doors covering the cutouts 520, 522 can be substantially similar to the door 524. The housing 502 can include multiple adjustable feet 540, 542, 544 (e.g., four rubber feet) for absorbing vibrations from the system 500 and for assisting in leveling the system 500. The space surrounded by the walls and doors of the housing 502 can form a build chamber having a controlled or controllable inner temperature.

The system 500 includes a build plate 548 movably disposed within the housing 502. The build plate 548 can define a substantially planar or flat structure on which the chocolate can be directly or indirectly printed. The system 500 can include a build plate carriage (e.g., translation plate) for supporting and providing movement or adjustment to the build plate 548 position. The carriage can include a bottom support 552 disposed below the bottom surface of the build plate 548, and a rear support 554 extending behind the rear surface of the build plate 548. The build plate 548 can be detachably secured to the carriage, allowing the build plate 548 to be removed from the housing 502 after printing.

The rear support 554 can be movably coupled to a lead screw 556 extending between the top and bottom inner surfaces of the housing 502. The lead screw 556 can be threaded into a coupler 558 attached to the rear support 554 and having a threaded opening complementary to the threads of the lead screw 556. Automated or manual rotation of the lead screw 556 provides incremental vertical adjustment of the position of the build plate 548 within the housing 502. The system 500 can include two linear guide rods 560, 562 disposed on either side of the lead screw 556 and extending between the top and bottom inner surfaces of the housing 502. The guide rods 560, 562 can slide through openings in guide couplers 564, 566 (e.g., in a non-threaded manner) disposed on the rear support 554 to ensure proper orientation of the build plate 548 as the vertical position of the build plate 548 is adjusted.

The system 500 includes an extrusion assembly 568 movably disposed within the housing 502. In some embodiments, the extrusion assembly 568 can be moved relative to the build plate 548. In some embodiments, the build plate 548 can be moved relative to the extrusion assembly 568 for vertical adjustment during printing. The extrusion assembly 568 can be mounted to a translation system capable of moving the extrusion assembly 568 along the x, y and z axes. The extrusion assembly 568 includes a heating chamber 570 and a carriage 572 coupled to the translation system. The extrusion assembly 568 includes a cartridge 571 capable of being disposed at least partially within the heating chamber 570 for printing a food product.

The translation system includes a linear rod 574 extending parallel to and along the side wall 510. A support flange 576 with internal bearings can be slidably mounted to the rod 574, allowing for movement of the support flange 576 between the front and rear walls 504, 506 of the housing 502. The rod 574 can be coupled to an idler pulley mount 578 at or near the front wall 504, and coupled to a stepper motor 580 at or near the rear wall 506. A protrusion or switch 582 extending from the mount of the stepper motor 580 can act as an end stop for translation of the support flange 576.

An idler pulley mount 584 can be coupled to the front wall 504 near the opposing side wall 508, and a stepper motor 586 can be coupled to the rear wall 506 near the side wall 508. A chain or belt 588 can extend between the stepper motor 586 and idler pulley mount 584. A support flange 590 can be movably positioned over the belt 588. Rotation or movement of the belt 588 by the stepper motor 586 can actuate movement of the support flange 590 along the belt 588 between the front and rear walls 504, 506 of the housing 502. A linear rod 592 can be coupled to and extends between the support flanges 576, 590 in a direction substantially parallel to the rod 574.

The carriage 572 of the extrusion assembly 568 can be slidably coupled to the rod 592 to allow for side-to-side translation of the extrusion assembly 568 (e.g., an x-axis gantry). Belts 594 disposed between the support flanges 576, 590 can be actuated to rotate or move to move the extrusion assembly 568 along the rod 592. Connection of the support flanges 576, 590 with the rod 592 results in the support flanges 576, 590 being moved back-and-forth during actuation of the belt 588 (e.g., a y-axis gantry). Belts 596 disposed between the idler pulley mounts 578, 584 can be actuated to rotate or move one or more components of the translation system. For example, one belt of belts 596 can be mechanically coupled to the stepper motor 580 and control one diagonal movement of components of the translation system, while another belt of the belts 596 can be mechanically coupled to the stepper motor 586 for controlling another diagonal movement of components of the translation system.

The front wall 504 of the housing 502 can include a mount 598 extending therefrom and enclosing electronics associated with a user interface 600 (e.g., a touchscreen, a graphical user interface, or the like) for operation of the system 500. The build chamber formed by the walls and doors of the housing 502 can be insulated to maintain the inner temperature within the build chamber. Generally, the build chamber can be defined by the front wall 504, the rear wall 506, the side walls 508, 510, the top wall 514 and an intermediate wall 602 disposed between the bottom and top walls 512, 514. The intermediate wall 602 can define the bottom surface of the build chamber, and is disposed below the build plate 548. Insulation layers 604-612 (e.g., foam insulation) can be disposed within the walls of the build chamber. In some embodiments, a food safe material (e.g., DELRIN® plastic) can be placed over the insulation layers 604-612 to maintain a hygienic environment inside of the build chamber and to maintain cleanability of the system 500.

The cooling system 614 can be disposed below the intermediate wall 602 and above the bottom wall 512, and encased by the walls of the housing 502. The cooling system 614 can be in the form of a vapor compression refrigeration system. The cooling system 614 can include an air control system 616 for input and return of air relative to the build chamber enclosure. The air control system 616 can be connected to the build chamber through tubing or pipes extending up to and through the intermediate wall 602 and related insulation 606. One or more air input lines 618 can extend through the intermediate wall 602, and one or more air output or return lines 620 can extend through the intermediate wall 602. The air in the housing 502 can thereby be cooled to the desired temperature, and circulated or exhausted as needed. The cooling system 614 circulates the air causing convective cooling to the printed chocolate, as compared to still air that would only cool via conduction. The convective cooling of the printed chocolate (along with the insulated build chamber) allows the system 500 to be used in a variety of environments and/or room conditions. The cooling system 614 can include an electronics and air pressure input 622 for receiving input regarding the desired temperature within the housing 502 and for controlling components of the cooling system 614 to achieve and maintain the desired temperature.

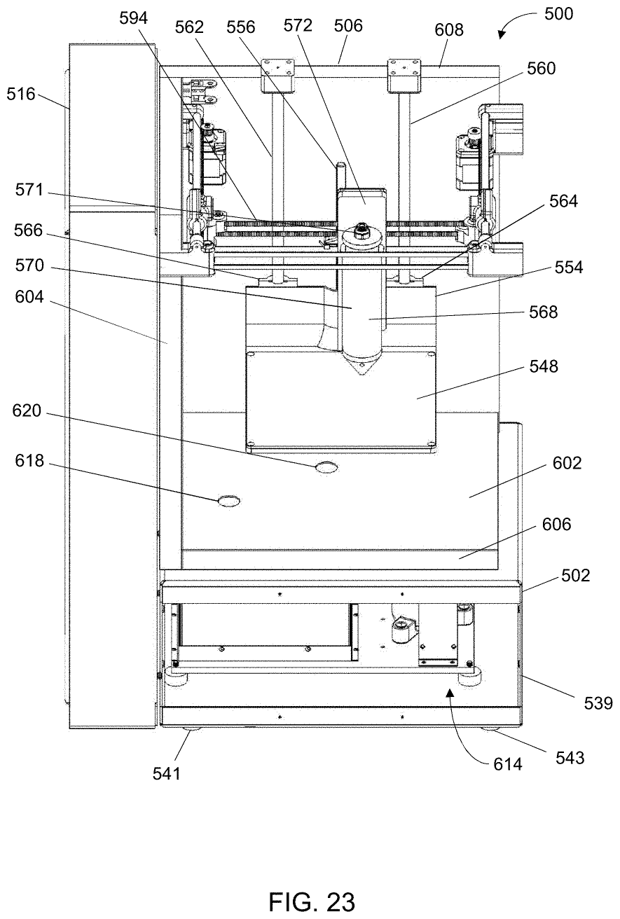

The adjustable feet 540, 542, 544 (and a fourth adjustable foot not visible) at the bottom of the system 500 can assist in absorbing vibration and/or movement from the cooling system 614 to ensure precision of the print is not disrupted. As illustrated in FIGS. 23, 24 and 26, the cooling system 614 can be mounted on an internal platform 539 with the platform 539 having anti-vibration mounts 541, 543, 545 (and a fourth anti-vibration mount not visible). The anti-vibration mounts 541, 543, 545 can be positioned on the inner surface of the bottom wall 512 and, in combination with the adjustable feet 540, 542, 544, absorb vibrations and/or movement from the cooling system 614. Thus, any vibrations from the cooling system 614 can be absorbed without progressing upwards to the printing assembly. The chamber housing the cooling system 614 is separated from the build chamber by the intermediate wall 602 to ensure that the build chamber remains food-safe and temperature controlled.

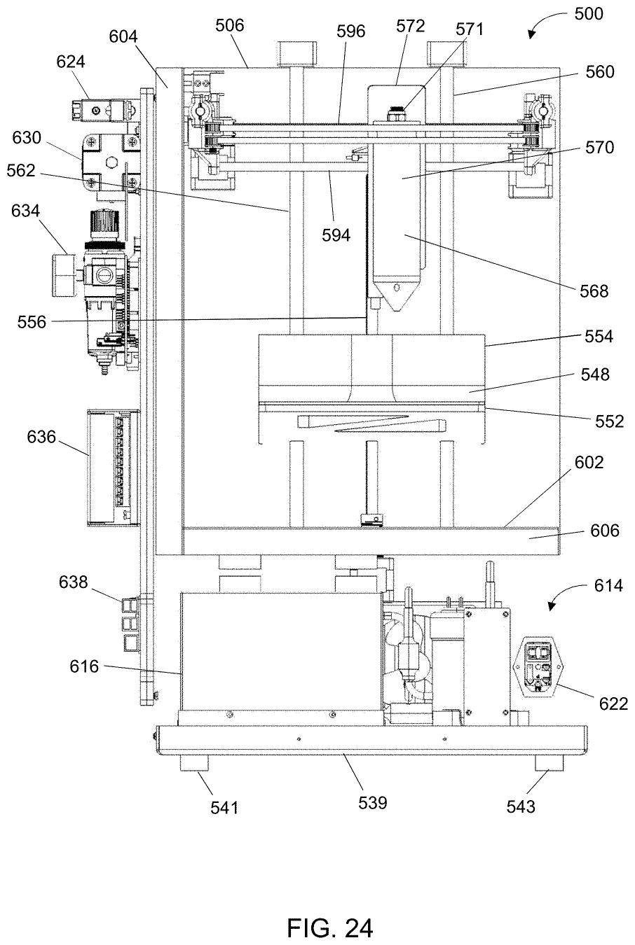

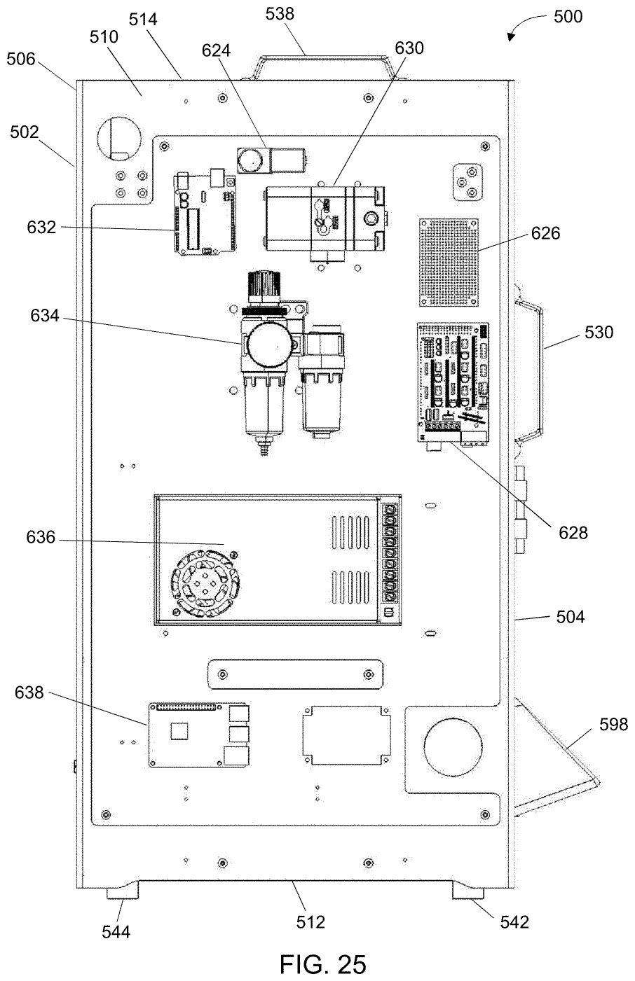

As noted above, the enclosure 516 can be used to surround and protect various electronics associated with operation of the system 500. With reference to FIGS. 24 and 25, the system 500 can include a solenoid air pressure valve 624, an electronic circuit 626 for controlling operation of the heating chamber 570, an Arduino Mega microcontroller 628 for running operation of the system 500, an electronic pressure regulator 630, and an Arduino Uno microcontroller 632 for controlling the temperature measurement within the extrusion assembly 568 (e.g., the temperature of the heating chamber 570, the temperature of the chocolate within the heating chamber 570, combinations thereof, or the like). For example, the heating chamber 570 can include one or more temperature sensors (e.g., three temperature sensors) and the tapered section 676 (e.g., nozzle) can include one or more temperature sensors (e.g., two temperature sensors) that can be averaged together with the microcontroller 632 for control of the temperature of the heating chamber 570. In some embodiments, a single temperature sensor can be used in the heating chamber 570. In some embodiments, a circuit can be used to average the sensor values. The temperature sensor(s) can be used for smart temperature correction by the system 500 to ensure the chocolate is printed at the desired temperature. The system 500 can include a pressurized air filter 634, a power supply 636, and a Raspberry Pi computing device 638 for controlling the user interface 600. In some embodiments, the air filter 634 can filter out particles down to 0.3 microns. In some embodiments, an air compressor and/or an air pump can be used for providing pressurized air.

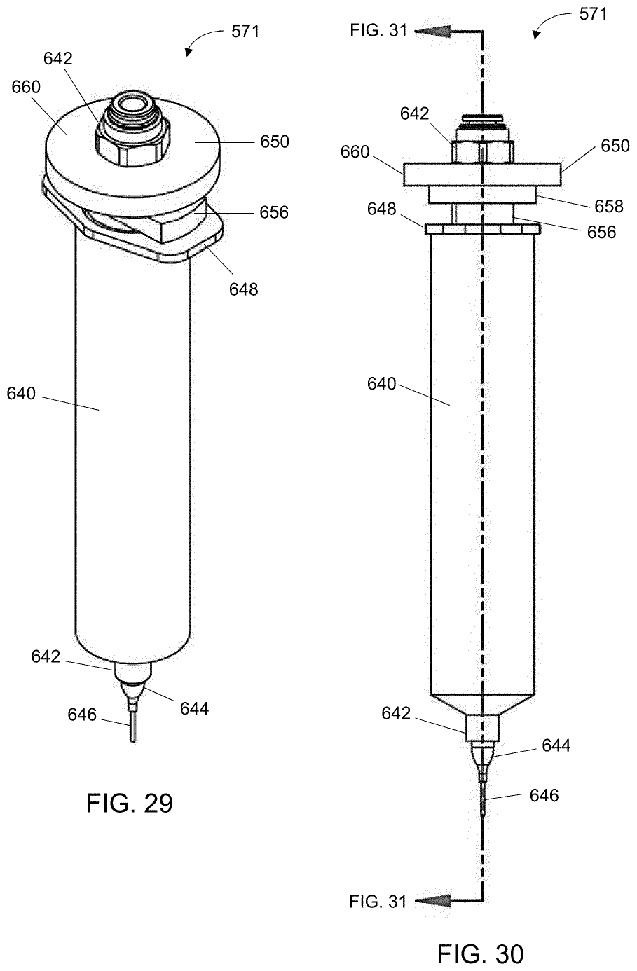

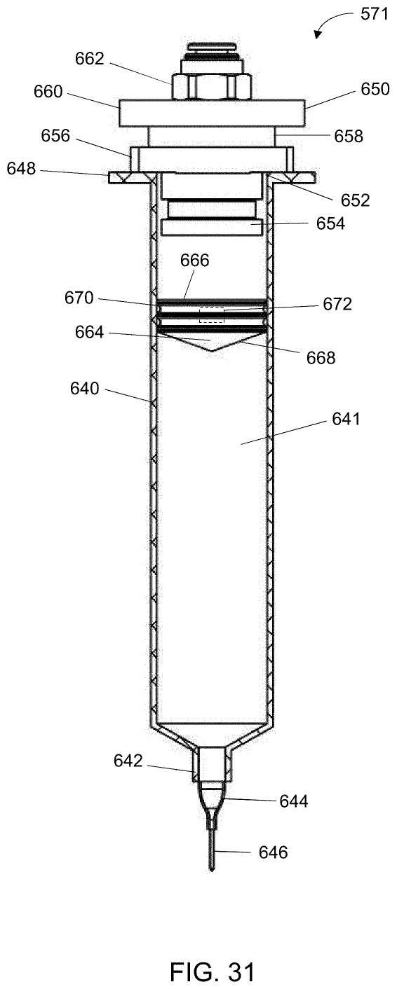

With reference to FIGS. 29-31, perspective, side and cross-sectional views of a cartridge 571 (e.g., a syringe) are provided. The cartridge 571 includes an elongated, cylindrical body 640 defining a substantially uniform diameter. The body 640 can be fabricated from plastic capable of withstanding heating of the body 640, while ensuring that heat is transferred to the chocolate within the inner chamber 641 of the body 640. One end of the cartridge 571 includes a smaller diameter section 642 connected to the body 640 by a tapered region. A luer lock tip 644 can be detachably coupled to the section 642 with a needle tip 646 having an opening or nozzle through which the melted chocolate can be extruded. The opposing end of the body 640 includes a flange 648 extending in opposite directions, defining the top of the body 640.

A pneumatic connector 650 can be slidably disposed within the body 640 through an opening 652 formed at the top surface of the body 640 (e.g., leading into the inner chamber 641). The connector 650 can include a stepped section 654 configured to be disposed within the body 640, and capable of receiving an O-ring (not shown) for creating a seal between the connector 650 and the inner walls of the body 640. Disposed above and against the flange 648, the connector 650 can include a stepped configuration with a first flange 656, an intermediate section 658, and a second flange 660.

The first flange 656 can define a substantially rectangular configuration defining a length dimensioned greater than the diameter of the opening 652, thereby providing an abutting surface against the flange 648, and a width dimensioned smaller than or equal to the diameter of the opening 656. The intermediate section 658 defines a cylindrical configuration with a diameter dimensioned smaller than the length of the first flange 656. The second flange 660 defines a radial flange having a diameter dimensioned greater than the length of the first flange 656. An air pressure quick disconnect connector 662 can be detachably coupled to and at least partially inserted into a central opening 655 of the connector 650, thereby being in fluid communication with the inner chamber 641 (see FIG. 33). The quick disconnect connector 662 can be used to attach the cartridge 571 to a line capable of being pressurized with air for extrusion of the chocolate.

The cartridge 571 includes a plunger 664 slidably disposed within the body 640. The plunger 664 can include a substantially flat top surface 666 and a tapered bottom surface 668. One or more O-rings 670 can be disposed around the sides of the plunger 664 to ensure a fluid tight connection between the plunger 664 and the inner walls of the body 640. A sensor 672 (e.g., a magnet, a detectable element, or the like) can be disposed within the plunger 664. As will be discussed in greater detail below, the sensor 672 can be used to determine the position of the plunger 664 within the body 640 which, in turn, can be used to determine the fullness or emptiness of the cartridge 571.

With reference to FIGS. 32 and 33, side and cross-sectional views of the heating chamber 570 are provided. The heating chamber 570 includes a substantially cylindrical body 674 with a tapered section 676 at a distal end. The heating chamber 570 can be fabricated from, e.g., aluminum, or the like, to allow for efficient heating. The heating chamber 570 includes a central bore 678 configured to receive therein at least a portion of the cartridge 571 (e.g., the body 640 of the cartridge 571). The central bore 678 can taper at the distal end and reduce in diameter, corresponding with the configuration of the cartridge 571 at the distal end and allowing the tip 646 to partially extend from the distal end of the heating chamber 570.

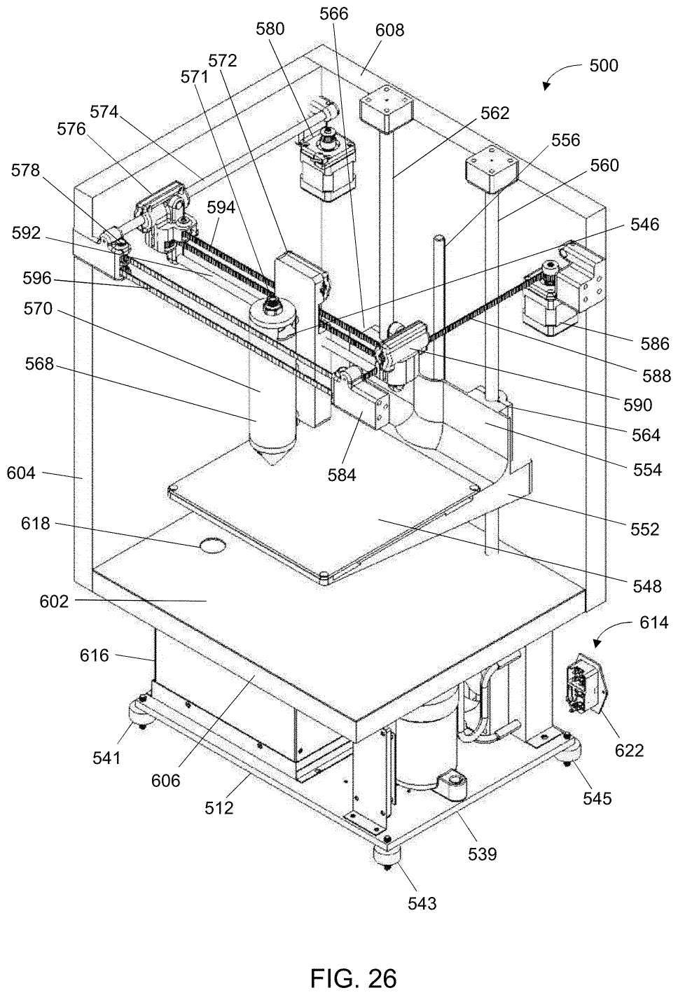

The opposing, proximal end of the heating chamber 570 includes an inner stepped section 680 configured to engage and interlock with the stepped configuration of the connector 650. The stepped section 680 allows for the cartridge 571 to be placed into the heating chamber 570 and the connector 650 to be rotated about 90° such that the first flange 656 and the intermediate section 658 engage and interlock with complementary steps and grooves in the heating chamber 570. In some embodiments, rather than the interlocking features described above, a combination of magnets can be used for locking and maintaining the height of the cartridge 571 within the heating chamber 570. The heating chamber 570 can include a lateral cutout 546 at the top surface (see, e.g., FIG. 26). During rotation of the connector 650, the cartridge 571 can remain substantially stationary, with the flange 648 of the cartridge 571 abutting a vertical wall of the lateral cutout 546 of the heating chamber 570 to prevent rotation of the cartridge 571. The interlocked configuration between the heating chamber 570 and the cartridge 571 (rather than a friction fit) ensures that the cartridge 571 will remain in place during pressurization. In addition, the interlocking assembly ensures that the cartridge 571 is food safe (e.g., locking of the heating chamber 570 and the cartridge 571 in a vertical direction achieved without the use of exposed fasteners, such as screws).

An elongated heating element 682 (e.g., resistive wire, nichrome wire, cupronickel allow, PTC rubber, or the like) can be continuous and concentrically wound around and secured to the outer surface of the heating chamber 570. In some embodiments, the heating element 682 can be a single, continuous component. In some embodiments, the heating element 682 can be formed from two or more components electrically coupled to each other. The heating element 682 can be wound around the heating chamber 570 such that the layers of the heating element 682 are spaced from each other. The spacing between each turn of the heating element 682 can be selected such that sufficient heat is provided to the heating chamber 570 to reach and maintain the desired temperature. In some embodiments, the resistive density can be changed according to the geometry of the nozzle and diameters of the inner cartridge 571 and/or tip to provide even heating to the chocolate on the inside of the cartridge 571.

Because the diameter of the tip 644 is smaller than the diameter of the body 640, a different duty cycle and/or power level for heating the chocolate within the cartridge 571 may be used at or near the tip 644. For example, the tip 644 may lose heat faster than the body 640. Dual heating can be used to allow for the chocolate to stay at a substantially consistent temperature along the entire height of the cartridge 571. In some embodiments, the temperature at the tip 644 can be set at a slightly higher temperature (e.g., about 0.5° C., about 1° C., or the like) than the temperature at the body 640 to control the viscosity of the chocolate right at the point of flow. In some embodiments, the temperature at the tip 644 can be set at a slightly lower temperature (e.g., about 0.5° C., about 1° C., or the like) than the temperature at the body 640 to start the solidification process of the chocolate before being extruded.

Insulation 684 can be concentrically wrapped around the heating chamber 570, including a tapered section 686 of the insulation 684 corresponding with the shape of the heating chamber 570. A sensor 688 (e.g., a Hall effect sensor) can be disposed within or at the outer surface of the heating chamber 570 near the distal end. The sensor 688 can detect the position of the sensor 672 within the cartridge 571, thereby indicating the fullness of the cartridge 571. In some embodiments, the sensor 688 can detect when the sensor 672 (e.g., magnetic element) passes a plane extending through the sensor 688, and can generate a signal to the user interface indicating that the cartridge 571 is empty or nearly empty.

The heating chamber 570 can include a temperature sensor 690 configured to detect the temperature within the cartridge 571. In some embodiments, the heating chamber 570 can include three temperature sensors in the main body 674 and two temperature sensors in the nozzle or tip 646. The heating chamber 570 can include a limit switch 692 disposed at or near the proximal end of the heating chamber 570. The heating chamber 570 can include a bed level probe 694 (e.g., an inductive sensor) at or near the distal end of the heating chamber 570. The limit switch 692 and the protrusion 582 extending form the stepper motor 580 can act as a locating system for determining a home location for the heating chamber 570 in the x and y directions. For example, upon turning on the system 500, the heating chamber 570 can pump into switches 692, 582 to home itself. From there, the system 500 can remember the position of the heating chamber 570 relative to the home location by counting steps on the stepper motors.

The probe 694 can ensure that the heating chamber 570 is level relative to the build plate 548 or, alternatively, that the build plate 548 is level relative to horizontal. The probe 694 can function similarly to the switch 692 except in a non-contact manner. The probe 694 can sense its home position when it is approximately 2 mm above the aluminum build plate 548 (4 mm if the build plate 548 is steel). The probe 694 can probe nine points on the build plate 548 in a 3×3 pattern and creates a mesh of the build plate 548 to account for not being perfectly parallel with the x-y gantry (e.g., the translation system). Instead of a spring and screw leveling system, the probe 694 automatically adjusts the level of the build plate 548 in a z direction as the heating chamber 570 moves in the x and y directions. In some embodiments, a food safe bellow can be added at the distal end of the heating chamber 570 such that individual mechanical components above the bellow do not need to be designated as food safe. As noted above, multiple components (including locking mechanisms and DELRIN® covers) can be used to ensure the build chamber is food safe.

In operation, the chocolate can be introduced in a melted (e.g., tempered) or unmelted form into the cartridge 571. In some embodiments, the heating system 300 of FIG. 18 can be used to melt the chocolate prior to introduction of the cartridge 571 into the heating chamber 570. The plunger 664 can be inserted into the cartridge body 640, the connector 650 can be inserted into the cartridge 571 and the cartridge 571 can be inserted into the heating chamber 570. The cartridge 571 can be rotated 90° to engage and interlock the connector 650 with the heating chamber 570. Due to the tapered configuration of the components at the distal end, interlocking the connector 650 with the heating chamber 570 can impart a force on the cartridge body 640 to maintain a tight position of the cartridge 571 within the heating chamber 570. The tight engagement between the heating chamber 570 and the cartridge 571 also ensures that the tip of the nozzle 646 is positioned in the substantially same position in a z direction for any cartridge 571 inserted into the heating chamber 570 (e.g., the position of the nozzle 646 within the heating chamber 570 for interchanged cartridges 571 remains substantially the same).

A pressurized air line can be connected to the connector 662. As pressurized air is controllably introduced into the cartridge 571, the pressurized air can be disposed within area 696 between the connector 650 and the plunger 664, and melted chocolate can remain in area 698 below the plunger 664. Upon an increase in pressurized area in area 696, the plunger 664 can be forced downwardly, resulting in chocolate extruded from the tip 646. A force is thereby imparted on the chocolate for extrusion without direct contact between the pressurized air and the chocolate.

While exemplary embodiments have been described herein, it is expressly noted that these embodiments should not be construed as limiting, but rather that additions and modifications to what is expressly described herein also are included within the scope of the present disclosure. Moreover, it is to be understood that the features of the various embodiments described herein are not mutually exclusive and can exist in various combinations and permutations, even if such combinations or permutations are not made express herein, without departing from the spirit and scope of the present disclosure.

1. A food product printer system, comprising:
a cartridge configured to receive a food product; and
a heating chamber including an opening for placement of the cartridge at least partially therein, the heating chamber configured to heat the food product to a predetermined temperature for extrusion of the food product from the heating chamber in melted form.

2. The food product printer system of claim 1, comprising an elongated heating element concentrically wound around and disposed against an outer surface of the heating chamber.

3. The food product printer system of claim 1, comprising one or more heating elements positioned against an outer surface of the heating chamber.

4. The food product printer system of claim 1, wherein the predetermined temperature is a range from about 30° C. to about 32° C.

5. The food product printer system of claim 1, comprising a connector disposed within a distal end of the cartridge, the connector including a flange capable of interlocking with a corresponding opening in the heating chamber to maintain a position of the cartridge within the heating chamber.

6. The food product printer system of claim 1, wherein the food product is extruded from the heating chamber by pressurized air introduced into the cartridge, the pressurized air imparting a force directly on the food product to extrude the food product.

7. The food product printer system of claim 1, comprising a plunger slidably disposed within the cartridge.

8. The food product printer system of claim 7, wherein the food product is extruded from the heating chamber by pressurized air introduced into the cartridge, the pressurized air imparting a force on the plunger to extrude the food product, and the pressurized air is in direct contact with the plunger and imparts the force on the plunger without direct contact with the food product.

9. The food product printer system of claim 7, comprising a detectable element disposed on or within the plunger and a sensor disposed within or on the heating chamber near a distal end of the heating chamber.

10. The food product printer system of claim 9, wherein detection of the detectable element by the sensor is indicative of an emptiness of the cartridge.

11. The food product printer system of claim 1, comprising a cooling system configured to cool the environment surrounding the food product to cool the food product after extrusion from the heating chamber.

12. The food product printer system of claim 11, wherein the cooling system comprises an air inlet into a build chamber of a housing and an air outlet.

13. The food product printer system of claim 1, comprising a build plate movably mounted within a housing, the housing including the cartridge and heating chamber.

14. The food product printer system of claim 13, comprising a translation carriage coupled to a bottom surface of the build plate, and slidably coupled to vertical rods within the housing.

15. A food product printer system, comprising:
a housing including walls defining an inner build chamber;
a cartridge configured to receive a food product; and
a heating chamber including an opening for placement of the cartridge at least partially therein, the heating chamber configured to heat the food product to a predetermined temperature.

16. The food product printer system of claim 15, wherein the walls of the housing are insulated, and the food product printer system comprises a cooling system configured to cool the inner build chamber to cool the food product after extrusion from the heating chamber.

17. A method of three-dimensional printing of a food product, comprising:
placing a cartridge at least partially into a heating chamber, the cartridge including a food product;
heating the food product to a predetermined temperature within a heating chamber; and
extruding the food product from the heating chamber in melted form.

18. The method of claim 17, comprising cooling the environment surrounding the food product with a cooling system after extrusion from the heating chamber to cool the extruded food product.

19. The method of claim 17, wherein the cartridge includes a plunger slidably disposed within the cartridge, the method comprising introducing pressurized air into the cartridge to impart a force against the plunger to extrude the food product from the heating chamber, wherein the pressurized air is in direct contact with the plunger and imparts the force on the plunger without direct contact with the food product.

20. The method of claim 17, wherein the heating element comprises an elongated heating element concentrically wound around and disposed against an outer surface of the heating chamber.
